(19) United States
(12) Patent Application Publication
(10) Pub. No.: US 2026/0083061 A1
(43) Pub. Date: Mar. 26, 2026

(54) Multi-Arm Robotic Harvesting Apparatus

(71) Applicants: Board of Trustees of Michigan State University, East Lansing, MI (US); The United States of America, as Represented by The Secretary of Agriculture, Washington, DC (US)

(72) Inventors: Zhaojian LI, Ann Arbor, MI (US); Renfu LU, Okemos, MI (US); Kyle M. LAMMERS, Okemos, MI (US); Kaixiang ZHANG, Okemos, MI (US); Keyi ZHU, East Lansing, MI (US)

(73) Assignees: Board of Trustees of Michigan State University, East Lansing, MI (US); The United States of America, as Represented by The Secretary of Agriculture, Washington, DC (US)

(21) Appl. No.: 19/410,156

(22) Filed: Dec. 5, 2025

Related U.S. Application Data
(63) Continuation of application No. PCT/US2024/033362, filed on Jun. 11, 2024.
(60) Provisional application No. 63/472,437, filed on Jun. 12, 2023.

(51) Int. Cl. A01D 46/30; A01D 46/20; A01D 46/253; B25J 5/00; B25J 9/16; B25J 15/06

(52) U.S. Cl. CPC A01D 46/30; A01D 46/20; A01D 46/253; B25J 5/007; B25J 9/1676; B25J 9/1682; B25J 9/1697; B25J 15/0625

(57) ABSTRACT

A multi-arm robotic harvesting apparatus is provided. In another aspect, a robotic harvesting apparatus and method automatically optically locate a fruit in a tree, move and align an arm to the fruit, apply a vacuum pressure to temporarily pull the fruit against an end of the arm, rotate the arm to pick the fruit off of the tree, retract the arm and attached fruit, release the vacuum pressure to drop the fruit onto a receiving surface, and simultaneously operate another arm relative to another fruit on the same tree, while avoiding a collision between the arms. A further aspect of a mobile robotic harvesting apparatus and method applies a vacuum pressure to multiple robotically and automatically movable, fruit picking arms from a single vacuum pump, and the apparatus includes a shared optical perception system and programmable controller.

### CROSS-REFERENCE TO RELATED APPLICATIONS

The present application claims priority to U.S. provisional patent application Ser. No. 63/472,437, filed on Jun. 12, 2023, which is incorporated by reference herein.

### GOVERNMENT SUPPORT

This invention was made with government support under 5050-43640-003-000D awarded by the U.S. Department of Agriculture-Agricultural Research Service and 2024649 awarded by the National Science Foundation. The government has certain rights in the invention.

### BACKGROUND AND SUMMARY

The present application generally pertains to robotic harvesters and more particularly to a multi-arm robotic harvesting apparatus for fruit in trees.

Harvest is the most labor-intensive operation in apple production, which accounts for more than 15% of the total production cost. Due to the lack of automated harvesting technology and a shrinking domestic labor pool, U.S. apple growers largely rely on migrant workers to hand pick more than 10 billion pounds of apples annually. Growing shortage of labor and rising costs in harvest pose a serious threat to the profitability and long-term sustainability of the U.S. apple and other specialty crop industries.

Various conventional attempts have been made to automate apple harvesting. These traditional devices, however, are very complex and prone to failure in the harsh and uncontrollable outdoor orchard environment. For example, U.S. Pat. No. 11,370,129 entitled “Vacuum Generating Device for Robotic Harvesting” issued to Salisbury, et al., on Jun. 28, 2022, and is incorporated by reference herein. This harvesting device employs vacuum tube coupled to an end-effector, with spring-loaded doors openable to allow apples to pass within the vacuum tube, and pads decelerating the apples as they leave the vacuum tube. Furthermore, the multi-hinged arms are likely to collide with each other during use.

In accordance with the present invention, a multi-arm robotic harvesting apparatus is provided. In one aspect, a robotic harvesting apparatus and method automatically optically locate a fruit in a tree, move and align an arm to the fruit, apply a vacuum pressure to temporarily pull the fruit against an end of the arm, rotate the arm to pick the fruit off of the tree, retract the arm and attached fruit, release the vacuum pressure to drop the fruit onto a receiving surface, and simultaneously operate another arm relative to another fruit on the same tree, while avoiding a collision between the arms. A further aspect of a mobile robotic harvesting apparatus and method applies a vacuum pressure to multiple robotically and automatically movable, fruit picking arms from a single vacuum pump, and the apparatus includes a shared optical perception system and programmable controller. In yet another aspect, a robotic harvesting apparatus and method include a programmable controller running software instructions to automatically align with and move multiple end-effector arms to pick and release fruit. An aspect of the present harvesting apparatus and method includes a perception system utilizing dual-laser scanning for sequential localization of apples, and an automatically controlled planning scheme and software instructions which facilitate coordinated movement of apple-picking manipulators; this coordination allows for effective approaching of the fruit and shared utilization of a centralized vacuum system for efficient fruit detachment.

The present robotic harvesting apparatus and method are advantageous over traditional devices. For example, the single vacuum source for multiple picking arms of one aspect of the present apparatus provides lighter weight and lower costs. As another example, the control logic and program instructions in one aspect of the present apparatus obtains simultaneous arm alignment and picking, that avoids arm collisions even in overlapping arm areas, while obtaining a faster picking rate than conventional approaches.

The present new manipulator beneficially includes a pan/tilt mechanism coupled with a linear actuator for moving the robot arm in and out of canopies, plus a rotation mechanism for fruit detachment. This manipulator is simple with only 4 degrees of freedom but dexterous and fast at reaching the target fruit. In one aspect, the present new picking mechanism uses a soft end-effector made of silicon, coupled with a vacuum machine. It can grip a target fruit that is within 12 mm (½″) distance to the end-effector, by way of non-limiting example. The soft end-effector can easily conform to different fruit sizes and shapes, and has no problem picking clustered apples, which has long been a major challenge in robotic harvesting. Furthermore, an efficient planning and control framework optimizes the picking order and accurately approaches target fruits. The robot causes minimum bruising damage and no quality degrading to the picked fruit. Additional advantages and features of the present system will become apparent with reference to the following description and claims, as well as the appended drawings.

### BRIEF DESCRIPTION OF THE DRAWINGS

FIG. 1 is a rear perspective view showing the present robotic harvesting apparatus adjacent an apple tree;

FIG. 2 is a front perspective view showing the present apparatus on a vehicle;

FIG. 3 is a front perspective viewing showing the present apparatus in a nominal position;

FIG. 4 is a cross-sectional view, taken along line 4-4 from FIG. 3, showing the present apparatus;

FIG. 5 is a side elevational view showing the present apparatus in the nominal position, specifically a soft end-effector holding a fruit;

FIG. 6 is a front perspective viewing showing the present apparatus in a nominal position;

FIG. 7 is a front perspective viewing showing the present apparatus in a nominal position;

FIG. 8 is a rear perspective viewing showing the present apparatus in a nominal position;

FIG. 9 is an exploded perspective view showing the present apparatus;

FIG. 10 is a perspective view showing one of the dual-arms of a manipulator module, employed in the present apparatus;

FIG. 11 is a perspective view showing a perception module employed in the present apparatus;

FIG. 12 is a partially exploded, perspective view showing the perception module employed in the present apparatus;

FIG. 13 is a perspective view showing an arm rotating assembly employed in the present apparatus;

FIG. 14 is a cross-sectional view, taken along line 14-14 from FIG. 13, showing the arm rotating assembly employed in the present apparatus;

FIG. 15 is an exploded perspective view showing the arm rotating assembly employed in the present apparatus;

FIG. 16 is a perspective view showing a vacuum valve control assembly employed in the present apparatus;

FIGS. 17A and B are diagrammatic top views showing the vacuum valve control assembly employed in the present apparatus, in different operating conditions;

FIG. 18 is a top elevational view showing the present apparatus, in different arm panning orientations;

FIG. 19 is a side elevational view showing the present apparatus, in different arm tilting orientations;

FIGS. 20A-C are diagrammatic views showing different apple assignment targeting sequence groupings, employed in the present apparatus;

FIG. 21 is a diagrammatic view showing software control logic employed in the present apparatus;

FIGS. 22A and B are diagrammatic view showing software control logic employed in the present apparatus;

FIG. 23 is a diagrammatic view showing a network structure employed with the software control logic of the present apparatus;

FIG. 24 is a diagrammatic view showing an apple detection process employed with the software control logic of the present apparatus;

FIG. 25 is a series of diagrammatic views showing an apple laser line triangulation process employed with the software control logic of the present apparatus;

FIGS. 26A-F are a series of diagrammatic views showing an apple laser line triangulation process employed with the software control logic of the present apparatus;

FIG. 27 is a diagrammatic view showing kinematic control of each of the arms for the manipulator module employed in the present apparatus;

FIG. 28 is a table showing a parameter versus value employed with the software control logic of the present apparatus;

FIG. 29 is a plumbing diagram for a vacuum system employed with the present apparatus;

FIG. 30 is a rear perspective view showing the lift of the present apparatus, in a raised position;

FIG. 31 is a side elevational view showing the lift of the present apparatus, in raised and forwardly advanced positions; and

FIG. 32 is an electrical circuit diagram of the present apparatus.

### DETAILED DESCRIPTION

A preferred embodiment of a multi-arm robotic harvesting apparatus is expected to enhance harvesting efficiency of a target, such as tree-hanging fruit. Specifically, a two-arm robotic module is used in combination with a perception algorithm to enable simultaneous detection and localization of apples, branches, and foliage for collision avoidance. An efficient multi-arm, collision-free planning algorithm effectively coordinates the two arms for maximized harvesting efficiency without arm-to-arm or arm-to-branch collisions. It is expected that the present system will achieve <2 seconds per fruit picking speed with >80% picking rate.

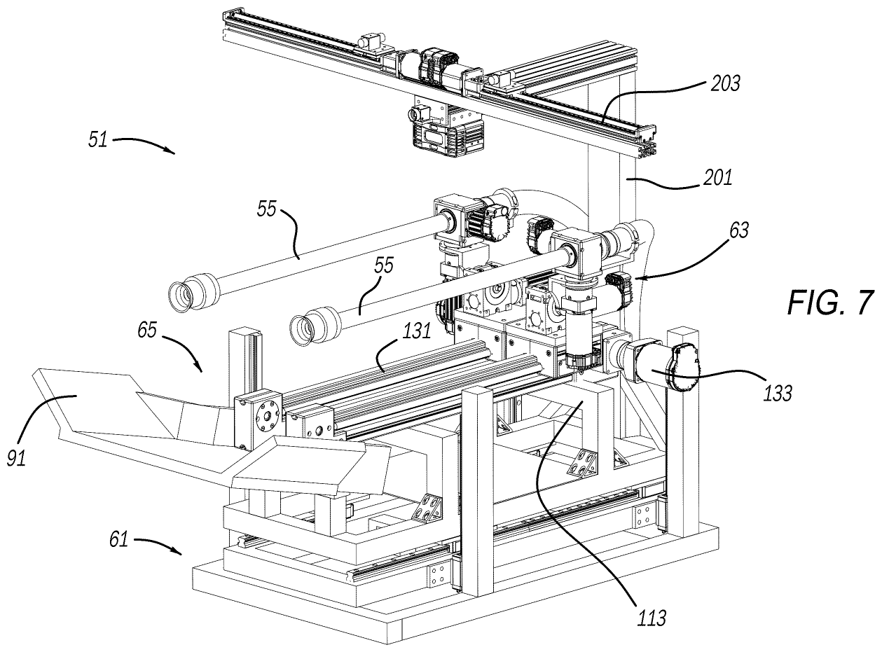

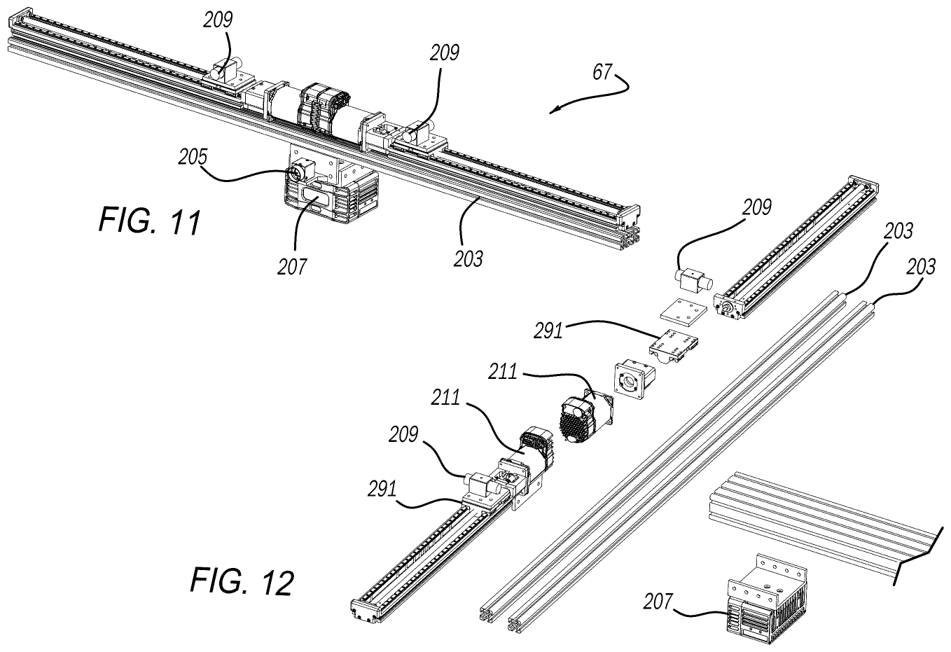

In general, the two arms share one perception module, and a planning algorithm efficiently coordinates the two arms. As shown in FIGS. 7 and 11, the perception system includes only one RGB-D camera and two line-laser scanners affixed to two linear stages. The RGB-D camera first provides a global view on the workspace with initial fruit localization estimates and then perform laser line triangulation. The two line lasers scan independently to accurately localize two target fruits based on our developed active laser-camera scanning scheme.

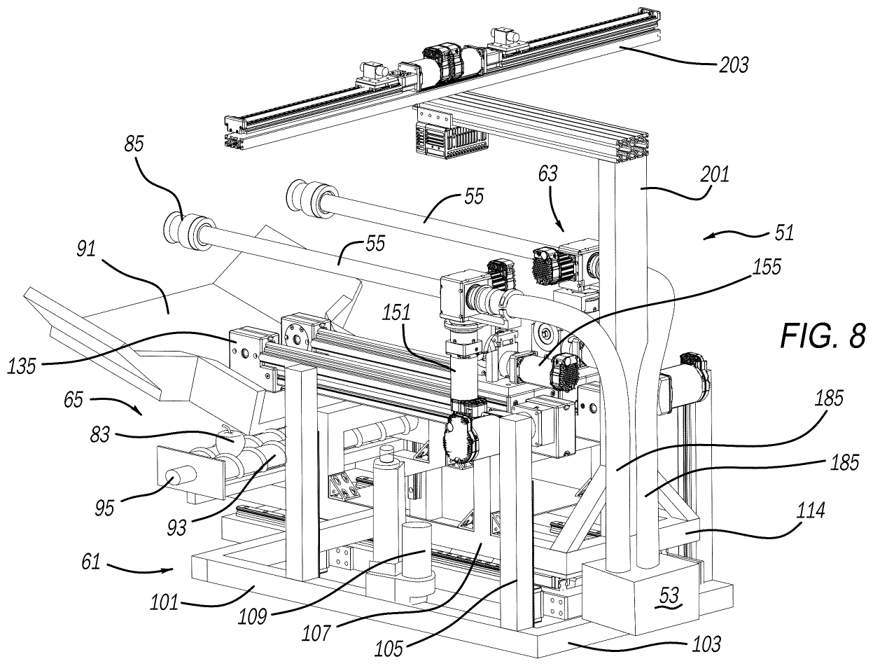

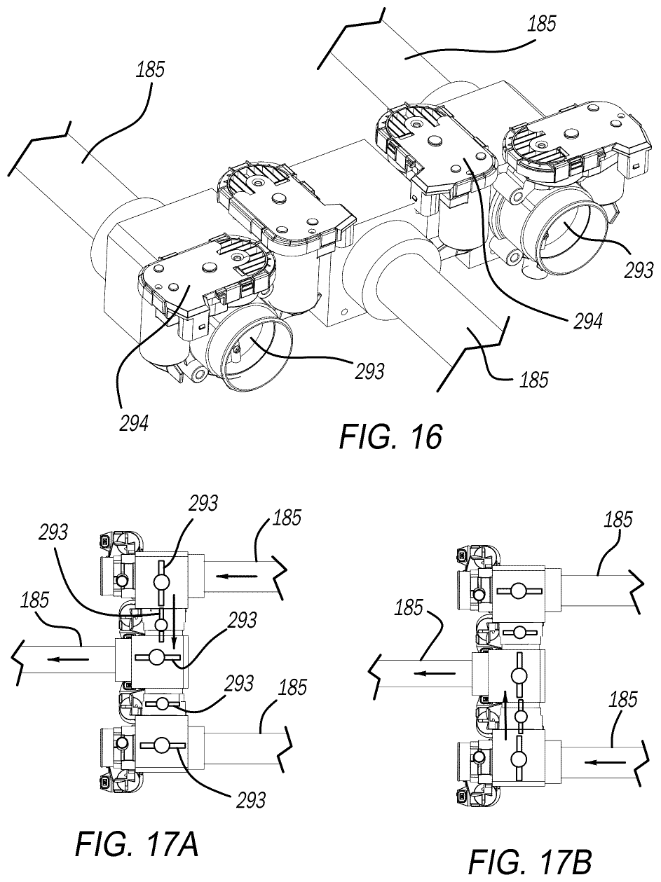

Furthermore, the present apparatus uses a single vacuum generator with a control valve (FIGS. 8 and 16) to support the operation of two arms to keep the system compact while minimizing the energy consumption. The two arms are coordinated in an alternated-operation fashion where the two arms pick fruits alternately such that one arm drops the first picked apple, while the other arm picks a second apple. With a fine-tuned timing scheme, the two arms can efficiently pick the fruits with only one vacuum source. Note that the spatial configuration of the two arms and the perception system beneficially enhance the system performance. Therefore, various configurations of the two arms and the perception module achieve the best tradeoff in terms of field of view, module dimension, volume of workspace, and picking efficiency. We exploit multi-criteria optimization such as the Analytic Hierarchy process or the Ordinal Priority Approach to obtain the best tradeoff among the conflicting multiple criteria listed above.

The present apparatus further includes branch/foliage detection and localization to enable collision-free capabilities. This is challenging due to the heavy inter-occlusions among fruits, branches, and foliage. Towards that end, panoptic segmentation assists in simultaneously identifying the fruit objects along with branch and foliage pixels from the color image acquired by the RGB-D sensor. To address the challenges of occlusions, a skeleton labeling and prediction technique is used to detect and interpolate tree branches with the exposed parts. Cloud point data is then used to provide the 3D structures (fruit, branches, and foliage) of the tree, and efficient data representations (e.g., apple as ball, branch as cylinder, and leaf as ellipse) to facilitate the planning algorithm which will be discussed next. It should be mentioned that while the point cloud data may not provide accurate localization information for apple fruits that is needed for robotic picking, larger localization errors for branches and leaves would be acceptable for the purpose of object avoidance by the robot.

An efficient collision-free multi-arm planning algorithm effectively coordinates the two arms without arm-to-arm or arm-to-branch collisions. With the 3D fruit and branch information from the perception module, a comprehensive motion planning algorithm determines the optimal picking sequence for each arm, as well as the trajectories of the two robot arms without the collision between the two arms or collisions of arms with branches. Towards that end, efficient mixed-integer programming techniques are used to optimize the assignment of the fruit picking tasks of each robot arm by taking into account 3D fruit locations, workspace overlap of the two robot arms, and branch information. Then, for each target apple, sampling-based incremental planning algorithms such as rapidly exploring random tree (“RRT”), where both static and dynamic obstacles are accommodated, generate a collision-free trajectory for manipulation movement. With the multiple robot arms involved, both centralized (i.e., optimizing the two-arm system as a whole) and decentralized (i.e., optimizing each arm individually with shared information between the two arms) are employed for planning schemes to achieve efficient planning with guaranteed real-time performance.

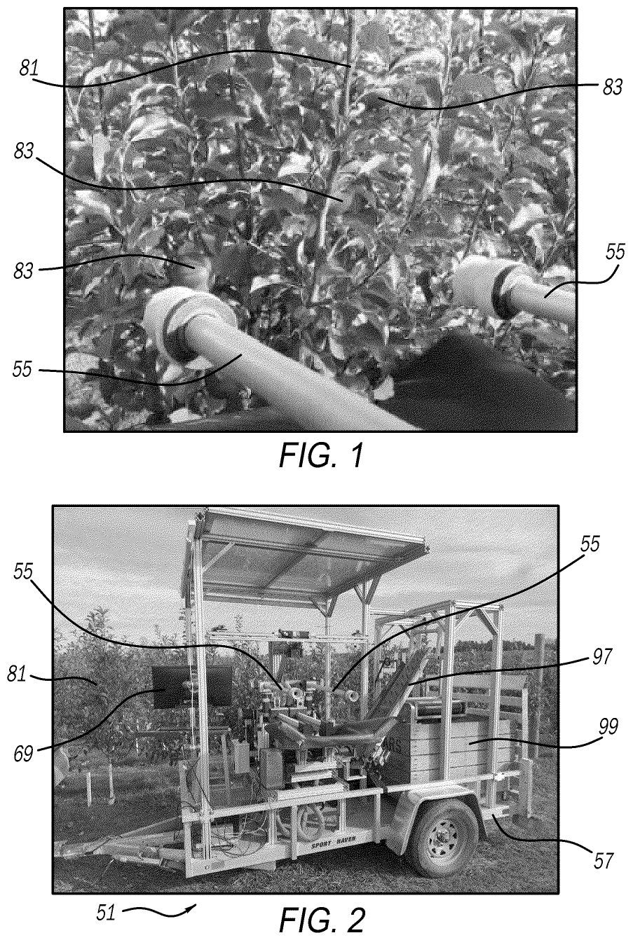

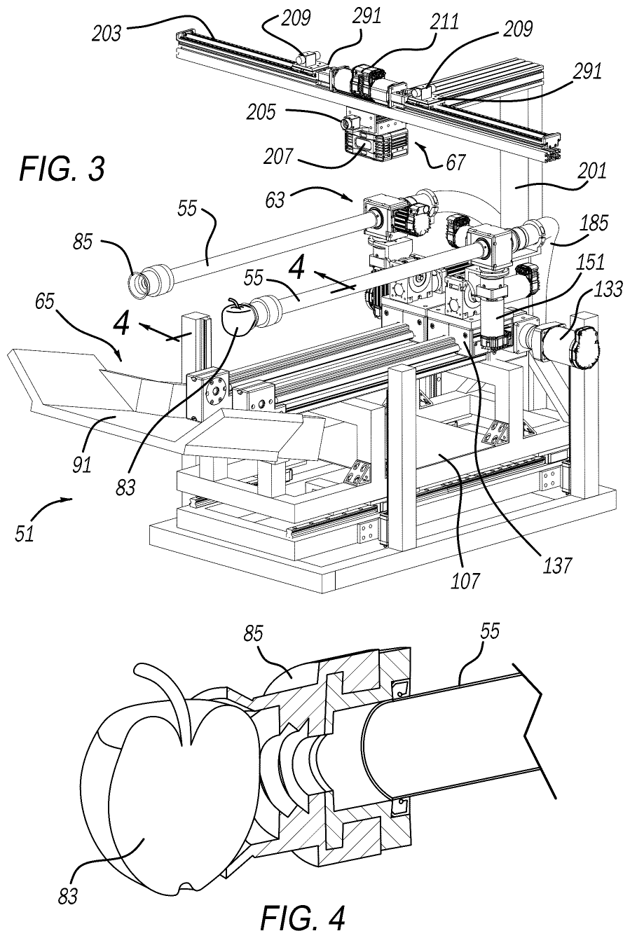

Reference should be made to FIGS. 1-4 for a more detailed disclosure of a preferred embodiment of the present apparatus and method, which employs a multi-arm robotic harvester 51. The harvester preferably uses a single vacuum source, such as a pump 53, to cause arm end-to-fruit suction in at least two arms 55. This is advantageously more compact and energy efficient than having separate dedicated vacuum sources for each arm. This synergistic feature also reduces weight which is beneficial since the harvester is mounted on a mobile trailer 57 or other vehicle, such as an autonomously controlled vehicle with wheels or wheel-driven tracks. Vehicle 57 includes a generally flat platform between opposite wheels, upon which a frame and sorting/storage bin are mounted. An operator chair or stool may optionally be located on the platform, and an automatically or manually adjustable covering sunscreen roof is installed on the platform to control the sunlight thereon so as to enhance the perception system for detecting and localizing fruit.

Harvester apparatus 51 includes a frame-movement module or assembly 61, a manipulator module or assembly 63, a dropping module or assembly 65, a perception module or assembly 67, and an electrical control module or circuit 69. Frame-movement module 61 is mounted upon trailer 57 and is connected to control module 69, also mounted to and portable with the trailer. When the trailer is moved along a row of fruit trees 81 and stops in front of a selected tree, control module 69 will automatically work with perception module 67 to energize one or more actuators in frame-movement module 61 and manipulator module 63 to advance and align each of arms 55 with an associated target apple 83. Control module 69 subsequently causes vacuum pump 53 to create a vacuum pressure in the associated arm 55 such that target apple 83 is sucked onto an openly flanged, distal end of an end-effector 85, secured to an end of arm 55.

Control module 69 subsequently causes an actuator to retract arm 55 and then releases the vacuum pressure so that picked apple 83 drops onto a declining chute 91 of dropping module 65. The base of the chute is made up of a rectangular aluminum plate covered with a soft foam cushion of 50 mm in thickness; the foam cushion allows the apples to drop from the highest position of the end-effector (approximately 80 cm) without causing fruit bruising, while keeping fruit bouncing to minimum. The manipulator can drop the picked apples at any spot above the chute without fully returning to its home position, thus reducing the overall fruit picking cycle time.

The dropped apple downwardly rolls or slide down chute 91 and onto a pair of screw or auger conveyor rolls 93, made of foam or other soft elastomeric material covering a central metallic rod. Conveyor rolls 93 have oppositely oriented spiraling threads which serve to centralize the apple along the interface between the adjacent rolls and move the apple toward an outboard side thereof. The rolls are driven by a motor actuator 95 which actively moves the apples in a spaced apart manner which advantageously deters jamming and bunching together of multiple apples. A diagonally inclined fork conveyor 97 has soft projecting fingers on an endlessly looped belt or chain, to lift each apple 83 from an end of rolls 93 and drops the apple onto a bin filling device which then places the apple in a storage bin 99 gently and evenly. The inclined conveyor and storage bin are also located on trailer 57.

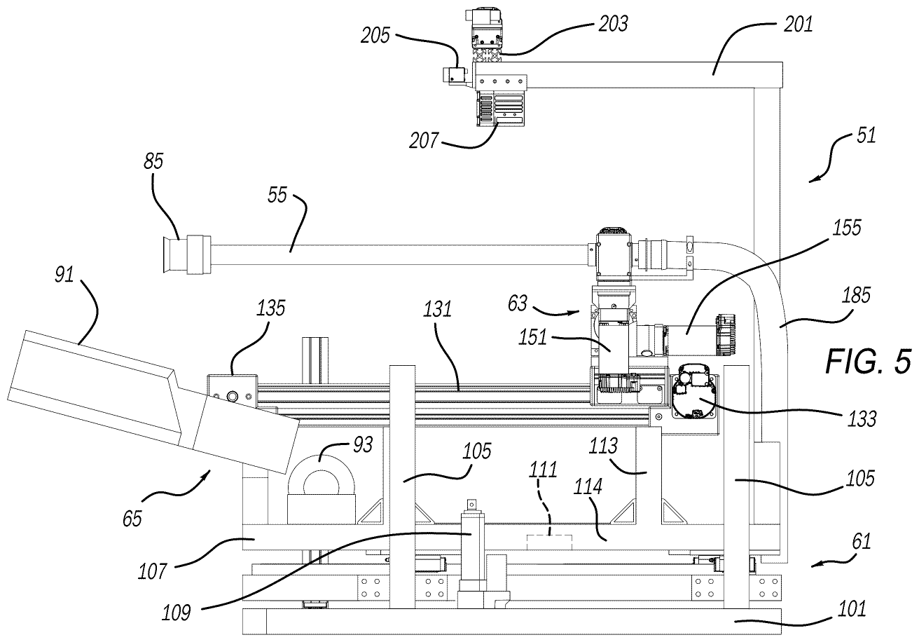

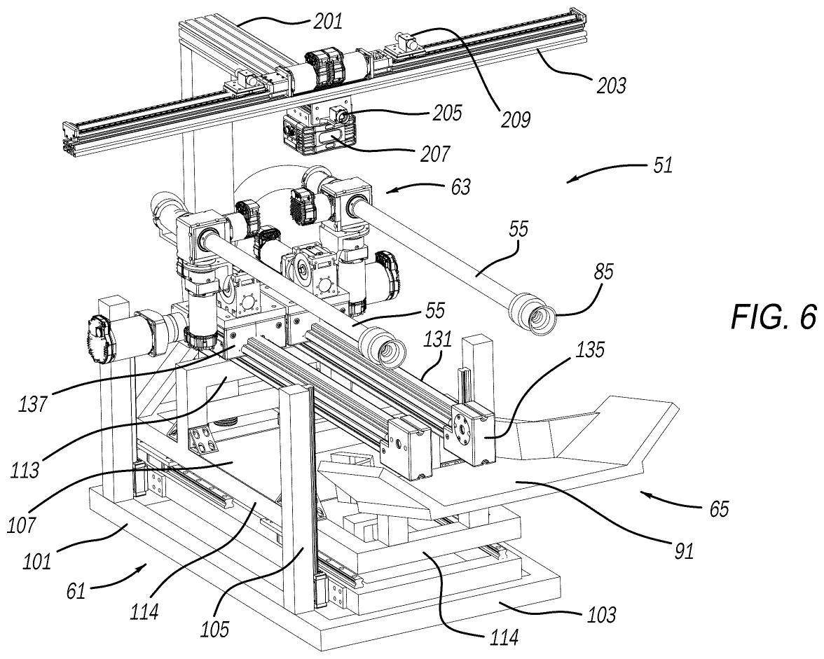

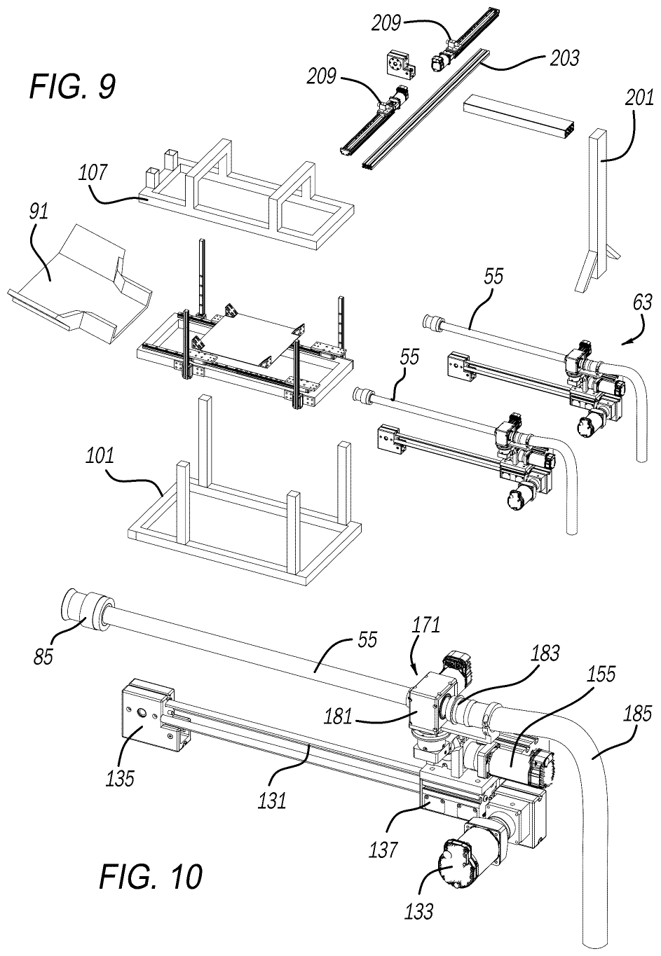

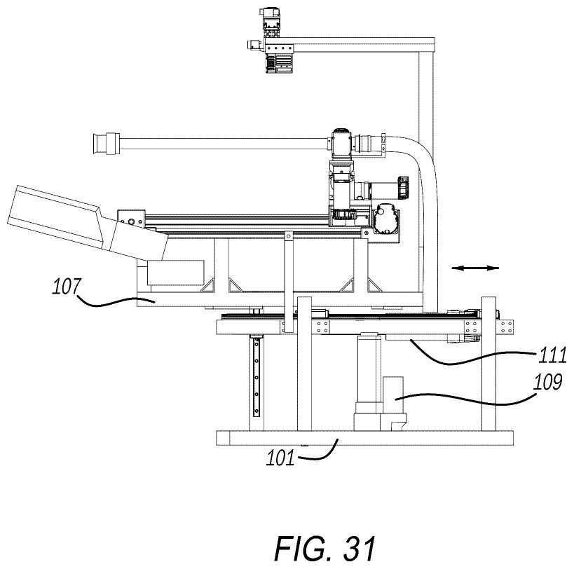

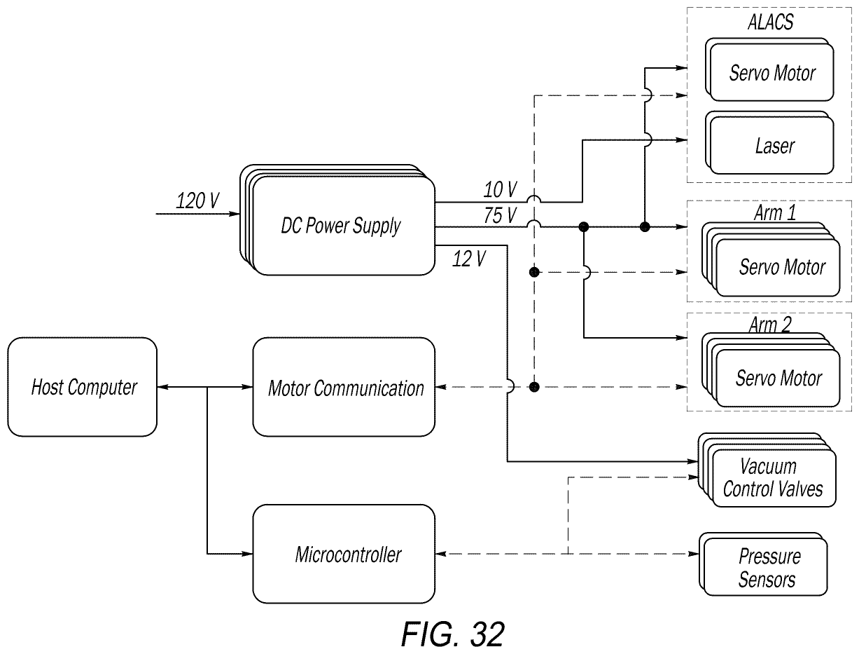

Referring to FIGS. 5-10, harvester 51 further includes a frame 101 having generally horizontally elongated base beams 103 and generally upstanding elongated posts 105 extending from the base beams. A lift 107 is coupled to the frame and hydraulically or electric motor movable in both vertical and horizontal directions relative to the frame. A lift elevator actuator and transmission assembly 109 cooperates with tracks internally mounted on posts 105 to raise and lower lift 107 relative to stationary frame 101, as can be observed by comparing the nominal lowered position of FIG. 5 and to the raised position of FIG. 30. A lift advancement actuator and transmission assembly 111 cooperates with tracks horizontally mounted on top of stationary frame 101 to horizontally advance and retract lift 107 relative to the frame, as can be observed by comparing the nominal retracted position of FIG. 5 and to the forwardly advanced position of FIG. 31. The lift movement is for initial tree alignment and access, gross movement, and may be either automatically controlled by the control module or manually operated.

Manipulator module 63 includes the at least two, generally horizontally elongated and parallel arms 55, which are mounted to inverted U-shaped buttresses 113, upstanding from horizontally elongated beams 114 of lift 107. For each arm, manipulator module 63 further includes a base rail 131 having an electric motor actuator and planetary gear box 133 at a proximal end, a pulley 135 or sprocket at a distal end, and a closed loop belt, cable or chain transmission moving therebetween. A slide block 137 is connected to the closed loop transmission and operably slides back and forth along rail 131 when actuator 133 drives the closed loop transmission. This motion acts to move each arm 55 and end-effector 85 toward and away from the target apple and/or associated tree.

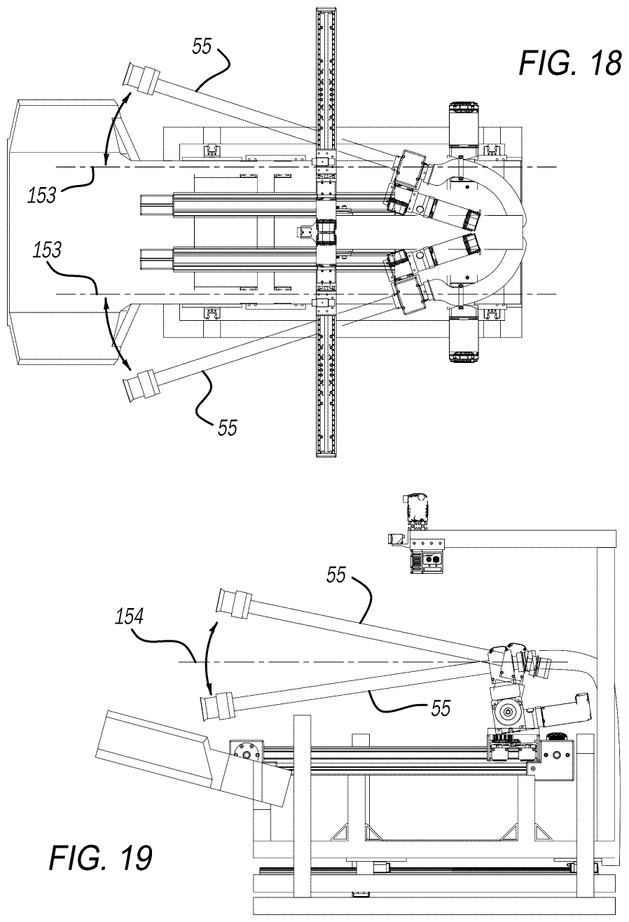

Moreover, for each arm, manipulator module 63 includes a panning electric motor actuator and planetary gear box 151 mounted upon slide block 137. When energized by the controller, panning actuator 151 causes each associated arm 55 and end-effector 85 to rotate side-to-side up to +/−30° on either side of a nominal central panning axis 153, as can be overserved in FIG. 18. A tilting electric motor actuator and planetary gear box 155 of manipulator module 63 is also coupled to slide block 137. When energized by the controller, tilting actuator 155 causes each associated arm 55 and end-effector 85 to rotate up or down, up to +30° and −15° on above or below a nominal horizontal tilt axis 154, as can be observed in FIG. 19. These motions allow each arm 55 and end-effector 85 to more finely align with the target apple in response to the perception module and control module.

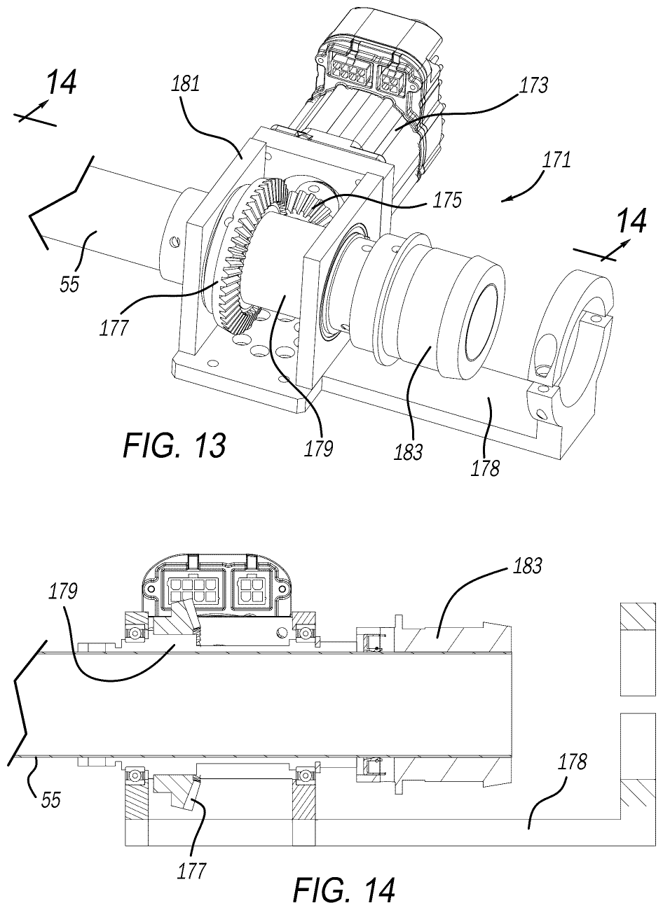

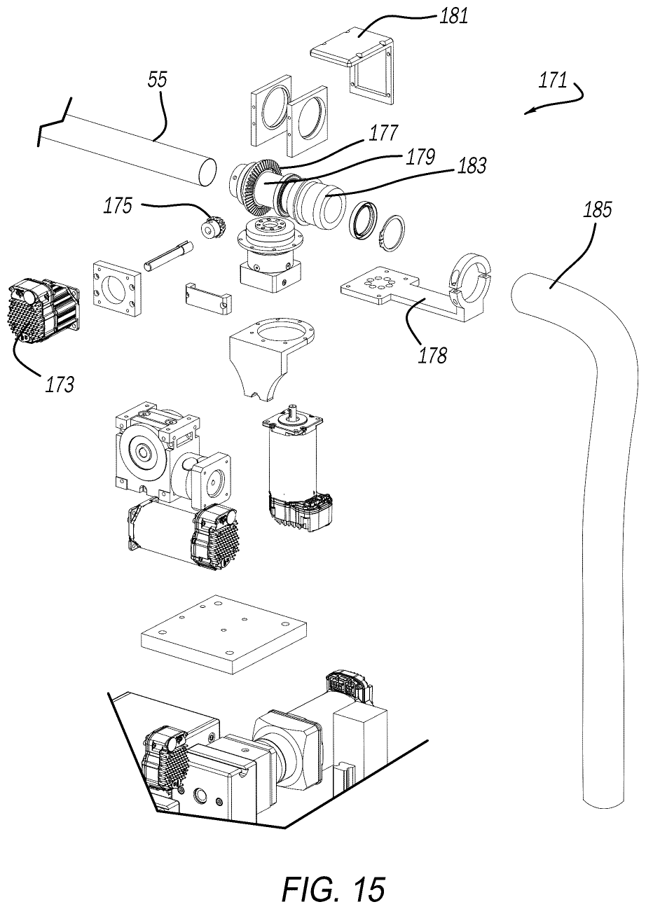

FIGS. 10 and 13-15 illustrate a rotatory assembly 171 for each arm 55 of manipulator module 63. A rotary electric motor actuator 173 and an associated beveled output gear 175 operably drive a hollow ring gear 177. Ring gear 177 surrounds and is screwed onto a hollow sleeve 179 located within a housing 181, mounted for movement with slide block 137 via braces 178. Hollow and tubular arm 55 is affixed to and rotates with sleeve 179. Furthermore, a hollow cuff 183 is coupled to sleeve 179 with an internal sealing ring therebetween which allows cuff 183 to remain stationary while sleeve 179 rotates. Cuff 183 has a laterally barbed end upon which a flexible vacuum tube 185 is clamped. This rotational movement detaches the apple from the tree but beneficially leaving a portion of the stem on the apple.

Each 4-DoF arm 55 is engineered to be compact yet offer high actuation speed, featuring three revolute joints and one prismatic joint. The first and second revolute joints are interconnected to form a pan and tilt module, while the third revolute joint creates a rolling motion of a 0.9 meters long hollow vacuum tube for detaching fruit. This arrangement achieves a maximum end-effector speed of up to 0.7748 m/s with a payload capacity of up to 1.5 kg. In the dual-arm configuration, two of these 4-DoF manipulators are positioned side by side with a 7 mm gap to ensure a maximum workspace overlap.

It is notable that each arm may be independently moved in the four degrees of freedom: advancing-retracting directions, panning directions, tilting directions, and rotary directions. This beneficially allows for simultaneous and/or alternating alignment and picking of apples, thereby reducing overall harvesting cycle time and efficiencies. However, collision avoidance sensing and control of the arms is desired, since the arms have overlapping areas of work, as will be more thoroughly explained later in this application.

The vacuum-based, soft end-effector 85 is used to grasp and detach fruits. The end-effector is a vacuum cup made of silicone rubber and is attached to the front end of the aluminum tube of arm 55 (i.e., the front end of the manipulator). A silicone material with a hardness of 40 Shore A and a cup shape design are preferred. In the present exemplary arrangement, the current cup shape geometric design has a smaller inner diameter and a larger outer lip. Each end-effector 85 is securely connected to the corresponding aluminum tube of arm 55 through an adapter. In one exemplary configuration, when vacuum pump 53 operates in a continuous mode, the soft end-effector can generate a suction force of about 47 N, which is sufficient for holding and detaching the fruit.

First, the design of end-effector 85 advantageously accounts for the unpredictable nature of apple contours and hanging orientations, which pose a challenge for end-effector performance. Thus, the present end-effector flexibly conforms to the diverse contours and orientations of apples, which ensures efficient gripping while reducing the risk of fruit bruising. Second, unlike traditional vacuum-based harvesting systems that suck apples into a large vacuum tube, the present system utilizes a compact end-effector coupled with a small-sized vacuum tube (of approximately 44.5 mm inner diameter or less) for fruit gripping, which prevents sucking in apples and minimizes the chance of sucking leaves and other debris into the arm. It is also advantageous that the present vacuum operated end-effector 85 can attract fruits within a distance of about 1.5 cm. This feature allows the manipulator to grasp the fruit even if it does not approach the target accurately.

The electric motor actuators are equipped with onboard controllers and encoders. The onboard controllers can execute velocity commands transmitted via EtherNet, and the embedded encoders can provide real-time position feedback, enabling precise measurement of the manipulator's status during operation.

Reference should now be made to FIGS. 5-8, 11 and 12. An upstanding neck 201 is coupled to and projects above the lift for movement therewith. A laterally elongated rail 203 is attached to the neck upon which are mounted an RGB laser line detection camera 205, a lower localization and time of flight (“ToF”) camera 207, and multiple line lasers 209. The cameras are stationarily affixed to the rail while the lasers are laterally driven by electro-magnetically actuated ball-screw transmissions 211. Cameras 205 and 207 are preferably used for all of the picking arms, while each fruit-scanning laser 209 is dedicated to its specific arm 55. The camera and laser operation will be more thoroughly discussed later in this application.

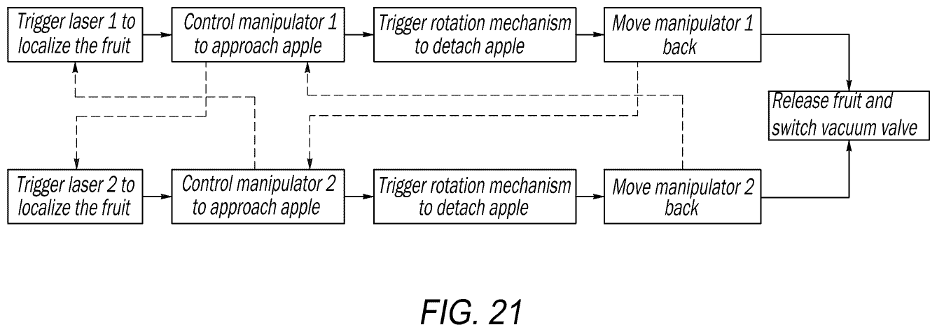

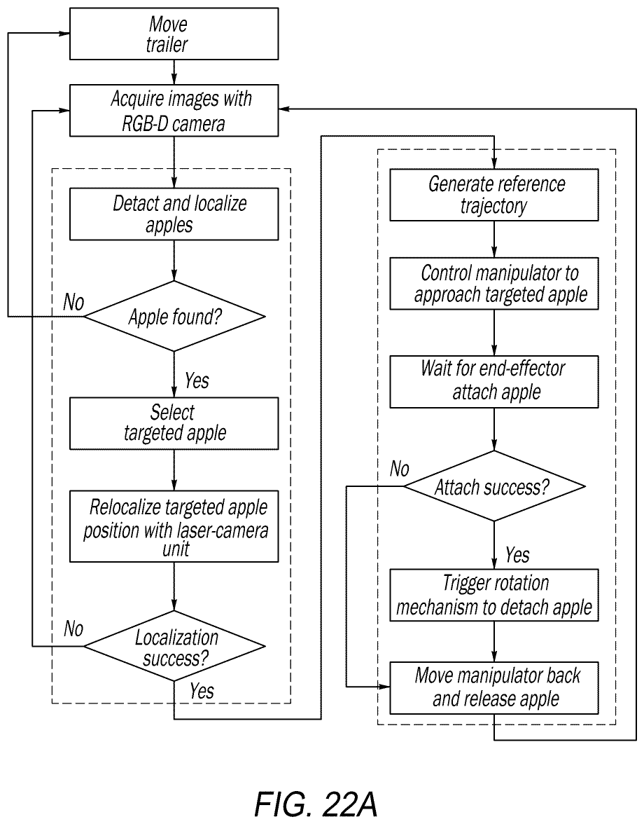

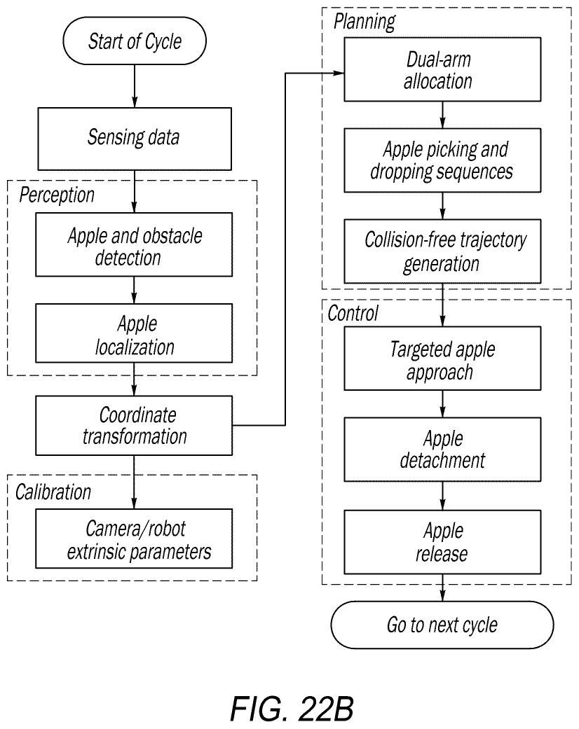

Control module and circuit 69 include a programmable computer controller 251 which is connected to the lasers, cameras, vacuum source for the arms, and the actuators for the lift and manipulator module. The controller includes a microprocessor and non-transient memory, such as RAM or ROM, within which programmed software instructions are stored. The controller is optionally connected to manual input switches, buttons, dials and/or a touch screen, and may show results or operating conditions of the harvester on an output display screen. Optional sensors for each actuator and the vacuum pressure may also send signals to the controller for automated real-time and closed-loop control of the actuators. The software instructions automatically control retraction and advancement of the arms toward and away from the target fruit, such as apples, by energizing and deenergizing electric motor actuators which move each of the arms separately from each other. Preferably, the software instructions cause one of the arms to advance while causing the other of the arms to retract, thereby avoiding collisions. Software logic, implementation flow charts of FIGS. 21, 22A and 22B show the software instructions and controller logic for two arm coordination. The operation of the perception and control modules is described in greater detail later in this application.

It is noteworthy that the present harvester can be used to pick other tree-hanging fruit, such as pears or oranges. U.S. patent application Ser. No. 17/188,177 entitled “System and Method for Harvesting Fruit” which was filed on Mar. 1, 2021, is incorporated by reference herein. Also, all of the references cited herein are incorporated by reference.

The perception module and control module will now be discussed in greater detail, with reference to FIGS. 7, 8, 11, 16, 17A-B and 29. Fruit detection and localization are facilitated by a sensor suite that includes two sensing modules: time-of-flight (“ToF”) based RGB-D camera 207 and an Active LAser Camera Scanner (“ALACS”) 205. The sensing modules are directly mounted above the manipulators 63, positioned at a distance of 1 meter from the front surface of the manipulators' workspace. The mounting position of the sensing modules offers the RGB-D camera and ALACS a comprehensive global view of the 48-inch wide workspace provided by the dual-arm manipulators.

Traditionally, commercially available RGB-D cameras struggle in highly occluded scenes and/or natural lighting conditions, leading to inaccurate localization in such scenarios. To address these challenges, the present ALACS module provides enhanced depth information in challenging occlusion and lighting conditions, which is especially useful in synergistic combination with the dual-arm system to support the expanded workspace provided by the dual-arm manipulator. Specifically, the ALACS system includes two linear motion slides, two vertical red 635 nm line lasers 207, and center-mounted RGB camera 205. Each line laser 207 is mounted on a linear motion slide 291 at a 20° angle relative to RGB sensor 205, thereby enabling horizontal scanning movements of up to 310 mm. These lasers are dedicated to localizing fruit for the manipulator on their respective sides.

The harvesting procedure requires precise control of the vacuum system to fully exploit the enhanced throughput offered by the dual-arm design. Additionally, the vacuum control module should facilitate fruit release without introducing additional delays to the harvesting operation. To achieve this, the vacuum force required for fruit attachment and detachment is generated by a commercial vacuum pump 53. In one configuration, the vacuum pump delivers a vacuum force of 90.1 inH²O with a flow rate of 211.9 cfm while consuming 2.3 kWatts of electrical power. As is illustrated in FIGS. 8, 16, 17A-B and 29, the vacuum source is connected directly to a combination of multiple valves 293 which operably regulate the airflow and enable rapid fruit release. These valves use a butterfly-style gate to quickly close specific channels, halting the flow of air. Actuated by small 12-volt DC motors 294 with actuation times of less than 1 second, the valves are controlled by micro-controllers that communicate with host computer controller 69. A pressure sensor 297 is integrated to provide feedback to controller 69, indicating successful fruit grasping by the end-effector.

Four valves are incorporated into the present harvesting apparatus: the first and second valves control fruit attachment and release for the first arm, while the third and fourth valves serve the second arm. The valve mechanism operates in two distinct statuses. In the first status, the entire vacuum source is directed towards the first manipulator, while isolating the second manipulator. This status, depicted in FIG. 17A, makes the first manipulator ready to harvest. A pressure sensor monitors the pressure in this channel, signaling successful attachment of an apple to the arm. After fruit attachment, the first arm detaches the fruit by activating the rotation mechanism that rotates the vacuum tube 180° and then returns to its home position.

To drop the fruit, the valve mechanism transitions to the second status as shown in FIG. 17B. In this status, the channel from the vacuum source to the first manipulator is sealed (i.e., the second valve is closed), while airflow is directed to the second manipulator (i.e., the third valve is opened). Meanwhile, the first valve between the channel of the first arm and the atmosphere is opened, facilitating rapid fruit release. With the full vacuum source now available, the second arm is poised to continue the harvesting cycle. Once the second arm completes its operations and returns to its home position, the valve mechanism will switch from the second status back to the first status. Alternately, sliding door-type or other valves may be used instead of butterfly valves.

In the present robotic fruit harvesting software control logic, efficient detection and localization are unique functions, where fruit detection involves segmenting fruit from complex backgrounds while a localization algorithm computes the 3D positions of the identified target fruits to guide robotic manipulation. In the natural orchard environment, apples often occlude each other, posing challenges for conventional deep-learning methods to differentiate them accurately. To enhance detection in occlusion scenarios, the present apparatus and method include an occluder-occludee relational network (“O2RNet”) that comprises a residual network backbone, a region proposal network, and an occlusion-aware modeling head. The developed O2RNet achieves an identification accuracy of over 90% on a comprehensive orchard image dataset. Furthermore, the localization process utilizes depth measurements from the RGB-D camera, generating a range matrix based on disparity maps for each detected apple. By calculating the mean value and employing back-projection techniques, the 3D positions of all detected apples are determined. This initial, rough localization is used as a starting point for the refined localization that will be discussed next.

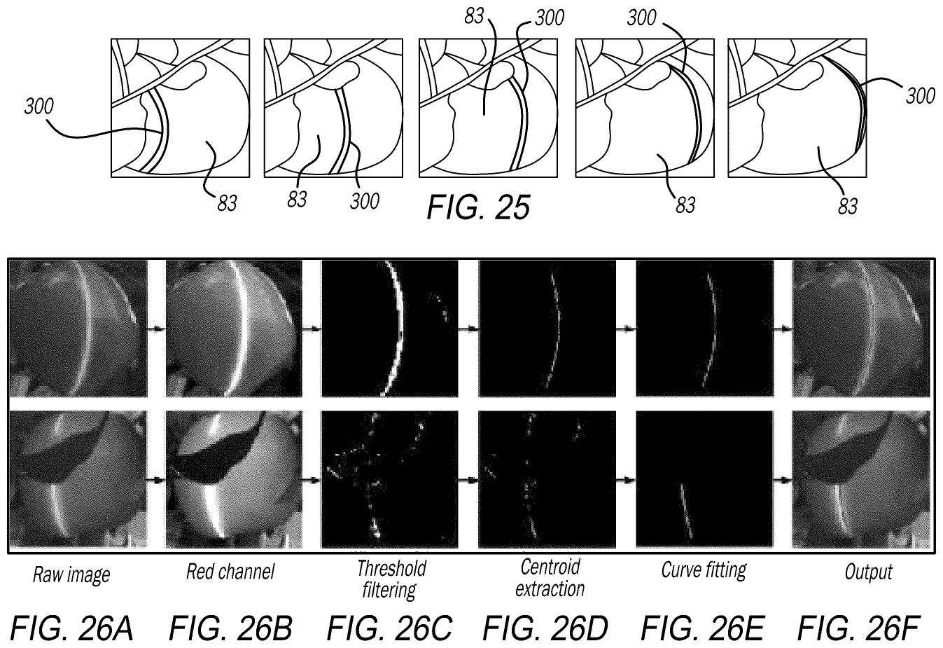

To overcome conventional RGB-D camera lighting and occlusion issues, an Active LAser Camera Scanner (“ALACS”), is used to enhance apple localization accuracy. The current ALACS system includes two red line lasers, each dedicated to refining apple localization for the manipulator on the same side of the system. The initial process behind the ALACS design is to direct the laser line 300 (see FIGS. 25 and 26) onto the surface of a target fruit and then utilize 2D image data and the laser-triangulation principle to compute the 3D position of the fruit. Each laser is activated alternately to scan the target fruit to refine its localization. The perception scheme designed for each laser is summarized as follows.

First, initialization: An initial laser position is calculated based on the rough apple location provided by the RGB-D camera. Subsequently, the linear motion slide adjusts the laser position, ensuring that the red laser line is projected onto the left half of the target apple.

Second, interval scanning: The RGB camera is triggered to capture an image once the laser arrives at the initial position. The linear motion slide then moves incrementally to the right, with pauses at each 1 centimeter increment for the RGB camera to capture corresponding images. This process yields a total of three images, each displaying the laser line projected onto three different positions. This scanning method aims to mitigate occlusion effects caused by leaves, branches, or other apples, thereby enhancing target fruit localization accuracy. By varying the laser's positions, the likelihood of complete obstruction by obstacles decreases, resulting in improved accuracy.

Third, refinement of 3D position: Each image captured by the RGB camera undergoes processing for extracting the laser line projected onto the apples surface. Computer vision techniques and laser triangulation-based methods are employed to extract the laser line and compute position candidates, respectively. Three position candidates are generated, and a comprehensive evaluation function is used to select the final target apple location.

Dual-arm planning and control will now be discussed. After determining the positions of the apples, the dual-arm system needs a plan for coordinated harvesting of apples that is generated in an efficient manner. Upon receiving a list of apple positions, the first step involves assigning and sequencing target apples amongst the dual arms. Then, for each apple, a reference trajectory is generated from the arm's home position to this designated apple, followed by another trajectory back to the home position or spot for fruit dropping. To ensure precise manipulation, a feedback-control method is employed, allowing the arm to closely track the generated trajectory. Lastly, a temporal-logic-based coordination strategy is designed to optimize the dual-arm harvesting process while accounting for the system's hardware constraints. This subsection serves as an introduction to dual-arm planning and control, covering: 1) target sequencing; 2) trajectory generation; 3) feedback controller; and 4) temporal-logic-based system coordination.

The target sequencing is based on an optimal assignment algorithm. Primarily, it takes N apple positions as inputs and categorizes them into three groups. The first group comprises apples only reachable by the first arm, the second group consists of those accessible solely by the second arm, and finally, the third group contains apples that both arms can harvest. Subsequently, the third group is assigned to Arm 1 and Arm 2 in a manner that balances their workload as evenly as possible.

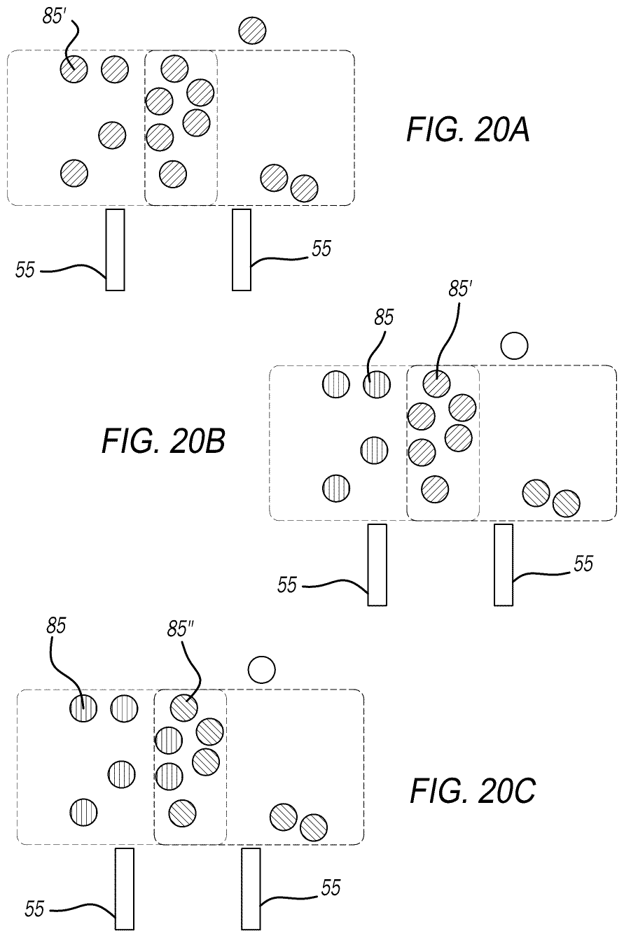

The assignment algorithm is illustrated in FIGS. 20A-C and detailed in the following Algorithm 1. FIGS. 20A-C illustrate the assignment algorithm, where FIG. 20A is the unassigned apple group, FIG. 20B splits apples into P1, P2 and P3, and FIG. 20C assigns the apples from P3 to each arm. More precisely, in this algorithm, p i denotes the position of apple i (i=1, 2, . . . , N), and d j (p i) is the distance between the Arm j's (j=1,2) home position and apple i. d j (p i)=·· means apple i is beyond the reach of Arm j. Given a set P, |P| denotes the cardinality of P, i.e., the number of elements of P. In Lines 1-10, the detected apples are divided into three groups based on their 3D positions, where P1 and P2 denote sets containing apples reachable solely by the first and second arms, respectively, while P3 includes apples within the workspace of both arms. Lines 11-30 are dedicated to further assigning the apples in P3 to either Arm 1 or Arm 2. The algorithm aims to assign a balanced number of fruits between the two arms, preventing the case that one arm overwhelmingly dominates the harvesting while the other arm is mostly idle. Once the apples are allocated to each arm, their harvesting priorities are sorted based on the distance between the arm's home position and the apple's position. Sorting them in increasing sequential order minimizes the risk of knocking off front-most apples in clusters, as harvesting an apple behind another fruit may cause the front apple to fall from the tree. This approach helps mitigate such situations effectively.

Algorithm 1 - Apple Assignment for Two Arms:

| Input: Apple target positions P = [pᵢ] | |
|---|---|
| Output: Assigned targets P₁ = {pᵢ_{ᵢ}}, P₂ = {pᵢ_{_{z}}} | |
| 1: | Let P₁ = { }, P₂ = { }, P₃ = { } |
| 2: | for all pᵢ ∈ P do |
| 3: | if d₁(pᵢ) < ∞ and d₂(pᵢ) = ∞ then |
| 4: | P₁ = P₁ ∪{pᵢ} |
| 5: | else if d₁(pᵢ) = ∞ and d₂(pᵢ) < ∞ then |
| 6: | P₂ = P₂ ∪{pᵢ} |
| 7: | else |
| 8: | P₃ = P₃ ∪{pᵢ} |
| 9: | end if |
| 10: | end for |
| 11: | $if \vert {P}_{1} \vert \geq ⌊ \frac{\vert P \vert}{2} ⌋ then$ |
| 12: | P₂ = P₂ ∪ P₃ |
| 13: | $else if \vert {P}_{2} \vert \geq ⌊ \frac{\vert P \vert}{2} ⌋ then$ |
| 14: | P₁ = P₁ ∪ P₃ |
| 15: | else |
| 16: | Let Σ = { } |
| 17: | for all pᵢ, ∈ P₃ do |
| 18: | Compute δᵢ_{₃} = d₂(pᵢ_{₃}) − d₁(pᵢ_{₃}) |
| 19: | Σ = Σ ∪{σᵢ}, where σᵢ = [pᵢ_{₃}, δᵢ_{₃}] |
| 20: | end for |
| 21: | while Σ ≠ ∅ do |
| 22: | $Let i = arg {min}_{{σ}_{i} ϵΣ} ( {δ}_{i} ) , where {σ}_{i} = [ {p}_{i} , {δ}_{i} ]$ |
| 23: | $if \vert {P}_{1} \vert < ⌊ \frac{\vert P \vert}{2} ⌋ then$ |
| 24: | P₁ = P₁ ∪{pᵢ} |
| 25: | else |
| 26: | P₂ = P₂ ∪{pᵢ} |
| 27: | end if |
| 28: | Σ = Σ\{σᵢ} |
| 29 | end while |
| 30: | end if |
| 31: | return P₁, P₂ |

Given a target fruit, the reference trajectory is then generated by utilizing the quintic (5th-order) spline interpolation. Specifically, for a given target apple position p_{d}=(x_{d}, y_{d}, z_{d}), the corresponding joint position q_{d}=(D_{d}, φ_{d}, θ_{d}) of the manipulator is calculated based on inverse kinematics, ensuring the manipulator's end-effector aligns with p_{d}. The initial joint position of the manipulator is denoted by q₀=(D₀, φ₀, θ₀). The primary goal of trajectory generation is to produce a continuous reference trajectory, starting at q₀ (i.e., the initial manipulator position) and ending at q_{d} (i.e., the target apple position). The interpolation algorithm generates a continuous reference trajectory for each joint's position, velocity, and acceleration. The reference trajectory is a function of time, which is suitable for the actuators to execute.

A spline interpolation-based trajectory generation technique, using joint D as an example, is hereafter described. The reference trajectories for the remaining joints are computed in a similar way. Specifically, let (t, Dᵣ(t), vᵣ(t), aᵣ(t)) denote the reference trajectory of joint D, where t is the time, Dᵣ is the joint position, vᵣ is the joint velocity, and aᵣ is the joint acceleration. The reference trajectories are formulated as a function of time in the following forms:

$${D}_{r} ( t ) = {α}_{5} {t}^{5} + {α}_{4} {t}^{4} + {α}_{3} {t}^{3} + {α}_{2} {t}^{2} + {α}_{1} t + {α}_{0} , \qquad ( 1 )$$

$${v}_{r} ( t ) = {\dot{D}}_{r} ( t ) = 5 {α}_{5} {t}^{4} + 4 {α}_{4} {t}^{3} + 3 {α}_{3} {t}^{2} + 2 {α}_{2} t + {α}_{1} ,$$

$${a}_{r} ( t ) = {\dot{v}}_{r} ( t ) = 20 {α}_{5} {t}^{3} + 12 {α}_{4} {t}^{2} + 6 {α}_{3} t + 2 {α}_{2} ,$$

where α₀, α₁, . . . , as are parameters of the quintic function. Given a user-specified time domain [t₀, t_{d}], D₀, and D_{d}, the reference trajectory should satisfy the following constraints:

$${D}_{r} ( {t}_{0} ) = {D}_{0} , {v}_{r} ( {t}_{0} ) = 0 , {a}_{r} ( {t}_{0} ) = 0 , \qquad ( 2 )$$

$${D}_{r} ( {t}_{d} ) = {D}_{d} , {v}_{r} ( {t}_{d} ) = 0 , {a}_{r} ( {t}_{d} ) = 0.$$

According to (1) and (2), the parameters α₀, α₁, . . . , α₅ can be computed using linear algebra. Note that in equation (2), the terminal velocity and acceleration of the joint are set as zero, which ensures that the reference trajectory is smooth and feasible to the manipulator.

The feedback controller aims to regulate the manipulator along the reference trajectory and finally reach the target position. To achieve this goal, embedded encoders are used to continuously measure the real-time position of the manipulator joints. Meanwhile, since the reference trajectory is a time-dependent function, its corresponding value at each time instant can be determined. The feedback error is then formulated by comparing the current position of the manipulator with the reference position. Leveraging the velocity controller, the movement speed of the manipulator is automatically adjusted based on the computed feedback error at each time step, ensuring the manipulator can approach the target position with high efficiency and accuracy.

A coordination strategy based on temporal logic is implemented to synchronize the operations of the whole system. Two primary constraints stem from the physical setup. First, with two lasers in place, there exists a risk of interference between them. Therefore, simultaneous scanning by both lasers should be avoided, necessitating alternating scanning operations. Second, the existing system has a single centralized vacuum system supporting two arms, restricting the harvesting of two apples simultaneously despite having two arms available.

Considering the aforementioned two constraints, the present apparatus and method utilize temporal logic to coordinate the system and achieve the goal of harvesting apples. Temporal logic is a formal language that enables the specification of system goals and constraints using temporal and logical operators. These operators include ¬(Not), Λ (And), V (Or), U (Until), ⋄ (Eventually), and G (Always). In our application, we initially group the left laser and left arm together as System 1 (i.e., Laser 1 and Arm 1), and the right laser and right arm as System 2 (i.e., Laser 2 and Arm 2). Each system operates with three statuses: Scan, Approach, and Collect. Here, Scan denotes the laser scanning process, Approach involves an arm moving towards an apple, and Collect represents the harvesting procedure requiring the vacuum system. The system's status can be represented as the Kronecker product of these subsystems, such as (Scan1, Approach2) indicating Laser 1 scanning and Arm 2 approaching an apple.

According to the aforementioned temporal and logical operators, the system goals and constraints can be formally expressed as

$$ϕ = {ϕ}_{sys} ⋀ {ϕ}_{goal} ⋀ {ϕ}_{sub 1} ⋀ {ϕ}_{sub 2} , and$$

$${ϕ}_{sys} = [ ¬ ( {S}_{1} ⋀ {S}_{2} ) ] ⋀ [ ¬ ( {C}_{1} ⋀ {C}_{2} ) ] , \qquad ( 3 )$$

$${ϕ}_{goal} = ⋀ [ G ( ♢ {C}_{1} \} ] ⋀ [ G ( ♢ {C}_{2} ) ] ,$$

$${ϕ}_{sub 1} = [ ¬ {A}_{1} U {S}_{1} ] ⋀ [ ¬ {C}_{1} U {A}_{1} ] ⋀ [ ¬ {S}_{1} U {C}_{1} ] ,$$

$${ϕ}_{sub 2} = [ ¬ {A}_{2} U {S}_{2} ] ⋀ [ ¬ {C}_{2} U {A}_{2} ] ⋀ [ ¬ {S}_{2} U {C}_{2} ] ,$$

where S₁, A₁, and C₁ represent the states of Scan1, Approach1, and Collect1, respectively. Similarly, S₂, A₂, and C₂ represent the respective states of System 2. Here Osys encapsulates the constraints imposed by both the lasers and the centralized vacuum system, as previously discussed. @goal outlines an objective of the harvesting robot: ensuring that both Arm 1 and Arm 2 continuously harvest apples until none remain in the scene. φ_{sub}1 and φ_{sub}2 delineate the sequential workflow of the two subsystems. For instance, if System 1 is tasked with harvesting an apple, it should first scan the apple to ascertain its precise position (S1), then maneuver the arm to approach the apple (M₁), and finally activate the vacuum mechanism to harvest the apple (C₁). After specifying all the system's goals and constraints, we utilize logical conjunction (Λ) to amalgamate these formulas for further analysis.

The operation of the harvesting apparatus and method will now be further set forth. The harvesting cycle for a single arm can be broken down into five distinct stages: apple detection and localization, manipulation, apple attachment, apple detachment, and apple release. Specifically, for each harvesting cycle, the perception component is first triggered to detect and localize the fruit. Subsequently, the manipulator advances towards the target fruit, followed by the utilization of the vacuum-based end-effector to securely attach the fruit. Once attached, the rotation mechanism is engaged to rotate the tube and detach the fruit from the tree. After the manipulator retracts to its home position, the valve mechanism switches its status to release the fruit.

The beneficially fast cycle time for the harvesting operation is now considered, by way of example and not limitation. As previously discussed, the RGB-D camera is integrated with the ALACS unit to achieve fruit detection and localization. The average time required for the RGB-D camera to detect and localize fruits within a single image is approximately 0.1 second, while the ALACS necessitates between 1 to 2 seconds to localize a fruit. Consequently, the entire perception component requires 1.1 to 2.1 seconds to localize a fruit. The time taken for the manipulator to approach the target apple ranges from 0.8 to 1.5 seconds, with an equal amount of time required for the manipulator to return to the home position. Fruit attachment to the end-effector typically takes between 0.2 to 1 second, while fruit detachment requires 0.7 second. Finally, the time for fruit dropping is equivalent to the time needed to switch the vacuum valve mechanism, which is approximately 0.5 second.

The current system includes two manipulators that need to collaborate by sharing the global perception component and a centralized vacuum system for efficient apple harvesting. The temporal-logic-based coordination algorithm ensures the smooth operation of the dual-arm system. This algorithm, tailored to consider both the global perception component and the centralized vacuum system, effectively coordinates the two developed coordination algorithm, manipulators to reduce harvesting time. Compared to a non-optimized scenario, the present coordination algorithm yields a reduction in harvesting time, ranging from 9.48% to 34.26%.

As an alternate control logic embodiment, a more effective planning algorithm for obstacle avoidance may be employed. This configuration includes a metric to quantify the degree of occlusion for each fruit. This metric will establish a relationship between the level of occlusion and achievable vacuum pulling force. By doing so, a confidence metric is created, allowing the system to identify and bypass highly occluded fruits.

The programmed software instructions and automated control logic of the deep learning-based perception algorithm robustly detects apples in clustered environments, and the active laser-camera scanning scheme obtains precise target apple positions. The 4-DOF manipulator, the vacuum-based end-effector, and the dropping component are designed to approach, detach, and collect the apple, respectively. In contrast to high DOF industrial manipulators used in most existing works, the developed 4-DOF manipulator has a simpler design, making it easier to assemble and more effective at approaching apples. In addition, unlike finger-based or blade-based grippers that require bulky or complex actuating mechanisms, the soft end-effector is affixed to the inlet of a vacuum tube (i.e., the front end of the manipulator) for fruit gripping, which eliminates the need for an intricate mechanism, allows for conformity to different fruit contours and orientations, and avoids fruit bruising during the harvesting process. The present approach is compact in structural design while also effectively utilizing multidisciplinary advances to enable synergistic harvesting functionalities. The present approach further integrates the RGB-D camera and a laser-camera unit to synergistically achieve robust apple detection and localization, that fuses a line laser with a camera to achieve millimeter-level localization performance.

In an exemplary embodiment, the computer and operation module are comprised of a high performance industrial computer and a workstation where users can monitor and control the robotic system. For example, and not by way of limitation, the industrial computer has an Intel® Xeon E2176G processor, 64 GB of RAM, and a NVIDIA Geforce RTX 2080 Ti graphic processing unit. This computer hosts all software algorithms and the communication connections to all components.

FIGS. 22A and B show the main logic/algorithm flow of the software system during apple harvesting. The software of the present robotic apparatus employs multi-disciplinary advances to enable various synergistic functionalities and coordination for achieving reliable automated apple harvesting. The logic flow of the apple harvesting cycle is as follows.

At the beginning of each harvesting cycle, the RGB-D camera is triggered to acquire images at 30 fps, by way of nonlimiting example. Based on the obtained image information, the deep learning-based technique detects and localizes the fruits within the manipulator's workspace. All identified apples are prioritized to generate a picking list of 3D apple locations. The criterion to determine the picking list was “closest apple first pick,” that is, the apple closer to the robot has higher priority for harvesting. Other criteria, such as travel cost based optimization can additionally or alternately be utilized. After obtaining the picking list, the one on top of the list is selected as the target fruit. Since location results provided by the RGB-D camera might not be sufficiently accurate, the developed laser-camera unit and corresponding perception scheme is triggered to scan the target fruit and calculate its 3D position. Given the ameliorative target apple location, the planning algorithm is used to generate a reference trajectory, and the control module will automatically actuate the manipulator to follow this reference trajectory to reach the fruit.

When the fruit is successfully attached to the end-effector, a sharp pressure drop will occur within the vacuum chamber which is monitored by a pressure sensor mounted inside the vacuum tube. When the pressure drops below a predetermined threshold, the rotation mechanism is triggered to rotate the whole aluminum tube by a certain angle, and the manipulator then retracts to pull and detach the apple (if the rotation action had not resulted in complete detachment of the fruit). After the manipulator reaches a predetermined dropping spot (detected by embedded encoders of motors), a vacuum control valve installed between the outlet of the vacuum machine and the inlet of the flexible vacuum hose is actuated, which causes a rapid loss of vacuum pressure in the arm tube, thus enabling the fruit to fall off the end-effector by gravity to the chute. If the manipulator fails to approach or attach the fruit (e.g., in the case of a collision with obstacles), the pressure sensor will detect the absence of a significant pressure drop. As a result, the system will trigger the manipulator to return back and start the next harvesting cycle, ensuring continuous harvesting operation.

The apple detection and localization software instructions and control logic are described in more detail as follows. The former aims at segmenting apples from the complex background areas, while the latter is to subsequently compute the 3D locations of the detected fruits that will be used to guide the robot to reach the target. The deep learning-based method combines a Mask R-CNN (or region-based convolutional neural network) backbone and a suppression end for apple detection, in combination with an occlusion-awareness structure to enhance the detection performance.

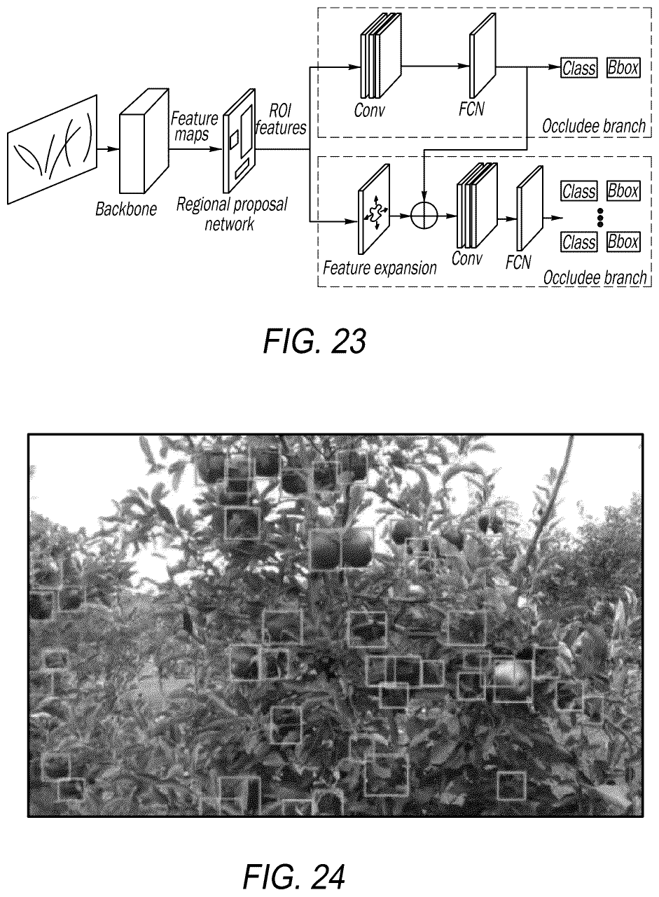

Specifically, in the cluttered orchard environment, apples tend to occlude each other, making it difficult for conventional deep learning-based approaches to detect both the occluder and occludee fruits. Therefore, a new network-occluder-occludee relational network (“O2RNet”) enhances detection performance in occlusion scenarios. FIG. 23 illustrates the network structure of the developed method, which includes three parts. The first part is a backbone whose functionality is to extract features from the entire image. A residual network 101 is used as the backbone due to its ability to keep strong semantic features at different resolution scales. The second part is a region proposal network (“RPN”), which aims at identifying promising regions of interest (“ROIs”) that are likely to contain an object. The RPN utilizes the feature maps provided by the backbone to generate promising ROls via a series of convolutional and fully connected layers. The RPN output is then fed into the third part, that is, an occlusion-aware modeling head, to decouple overlapping relations and segment the apples. The occlusion-aware modeling head includes an occluder branch and an occludee branch. The occluder branch follows the design of the object detection head in Faster R-CNN to prepare the cropped ROI features for the occludee branch. By combining the feature expansion structure and the cropped ROI features, the occludee branch can refine object boundaries and generate bounding boxes for the partially occluded apples. The O2RNet algorithm, on a comprehensive orchard image data set, is expected to achieve an identification accuracy of more than 90%. FIG. 24 shows an example of the detection results where bounding boxes represent the identified apples.

Once the fruit is detected, apple localization is performed with the depth measurements provided by the RGB-D camera. Specifically, the image pixels of the detected apple are extracted for each bounding box to create a range matrix based on the disparity map. The mean value of the range matrix is then calculated, and it is used as the depth range of the apple. Back-projection is utilized to determine the apple's 3D position by fusing the depth range with the center of the bounding box pixels. This procedure is performed for every bounding box to obtain the positions of all detected apples in the image.

Although a commercial RGB-D camera is compact and can provide dense environmental information, its depth measurements are sensitive to varying lighting conditions and lack stability when apples are partially occluded by branches or foliage. Such limitations would result in inaccurate apple localization, such that the present active laser-camera scanning scheme overcomes this traditional concern and enhances the apple localization accuracy. More specifically, the rough apple location provided by the RGB-D camera is used by the present laser-camera assembly to facilitate scanning of the target apple and the recalculation of the 3D position. The pseudo code of the active laser-camera scanning scheme is shown in Algorithm 2, and more details are introduced below:

Algorithm 2 - Active-laser camera scanning for apple localization:

Input: rough target apple location provided by the RGB-D camera
Output: refined target apple location

| | |
|---|---|
| 1. | Initialization |

```
  Based on the rough target apple location, compute an initial laser position Adjust the laser to
  the initial position with laser line being projected on
    the left side of the target apple
  Trigger the 2D color camera to capture image I₁
```

| | |
|---|---|
| 2. | Interval scanning |

```
  for k = 1, 2, 3,4 do
  Move the laser to the right by one centimeter Trigger the camera to
  capture image Iₖ₊₁
  end for
```

| | |
|---|---|
| 3. | Refinement of 3D position for k = 1, 2, 3, 4, 5 do |

```
    Extract laser line from image Iₖ
    Compute 3D location candidate qₖ based on laser triangulation techniques
  end for
  Select refined target apple location from {q₁, q₂, q₃, q₄, q₅} based on a holistic
    evaluation function
```

Initialization: After the target apple has been selected, the linear motion slide is controlled to adjust the laser towards an initial position so that the red laser line would be projected on the left half region of the target. To calculate the initial laser position, the rough target apple location provided by the RGB-D camera is transformed to the laser-camera unit's coordinate frame, which is used to regulate the linear slider to direct the laser line onto the left side of the target. Here the relative pose/transformation between the RGB-D camera and the laser-camera unit is carefully calibrated offline. Once the laser reaches the initial position, the 2D color camera is triggered to capture an image.

Interval scanning: The linear motion slide subsequently moves to the right by a total of 4 cm with 1 cm increments, and it pauses at each increment for the 2D color camera to capture a corresponding image. Through this scanning procedure, a total of five images will be collected, and in each image the laser line will be projected on different positions. FIG. 25 shows a set of example images of the target apple that are collected during the interval scanning. The motivation for using this scanning scheme is to alleviate the impact of occlusions caused by leaves, branches, and/or other apples to enhance the localization accuracy of the target fruit. Specifically, when the target apple is partially occluded by obstacles, moving the laser to various positions can reduce the possibility of laser lines being completely blocked by the obstructions, leading to a considerable improvement in the localization accuracy for the target fruit.

Refinement of 3D position: For each image captured by the 2D color camera, the laser line projected on the target apple surface is extracted and then used to generate a 3D location candidate. Image processing and laser triangulation-based techniques are exploited to accomplish laser line extraction and position candidate computation, respectively. Five position candidates will be generated as a result, and a holistic evaluation function is designed to select one of the candidates as the final target apple location.

Laser line extraction and position candidate computations are two main challenges in Step 3. Accordingly, the corresponding algorithms address the challenges by fully considering the hardware structure of the laser-camera unit. The algorithms are detailed in the following.

As illustrated in FIGS. 26A-F, laser line extraction mainly includes five steps. In the first step, the red channel information of the raw RGB image is chosen as the substrate for the laser line extraction. The RGB image has three color channels, and through preliminary tests, it is found that under the red channel, the laser line has higher contrast with the background of apples or foliage. Therefore, the red component of the raw image is selected to facilitate the following processing. In the second step, a threshold filter is used to segment the laser line from the background. The design of this filter is based on the observation that the pixel values of the laser line almost always approach saturation in the red channel. As there exists laser diffusion, the centroid points of the segmented outline are extracted in the third step. The polynomial function is used in the fourth step to fit a continuous curve based on the discrete centroid points.

If the target apple is occluded by foliage, there may exist multiple segments of the laser line. Under this circumstance, only the centroid points extracted from the most prominent segment of the target apple will be selected for curve fitting. Finally, the curve is used to represent the laser line position, and the image coordinates [uᵢ, vᵢ]^{T}∈P² (i=1, 2, . . . , n) of the curve portion belonging to the target apple will be outputted for the calculation of 3D position candidates.

The computation of position candidates is conducted with the laser triangulation-based technique. This technique effectively captures depth measurements by pairing a laser illumination source with a camera. Both the laser beam and the camera are aimed at the target object, and based on the extrinsic parameters between the laser source and the camera sensor, the depth information can be collected with trigonometry. In the present system, three extrinsic parameters are considered to describe the trigonometry model of the laser-camera unit. α∈P is the rotating angle of the the 2D color camera with respect to the laser, L∈P is the horizontal distance between the camera and the laser, and β∈P is the angular offset of the emitted laser line. α and β are constants, while L is variable (but measured) as the linear motion slide will move to different positions. α, β, and the initial value of L are obtained via offline calibration, and L will be updated online based on its initial value and the movement distance of the linear motion slide.

Next, a method is used to calculate position candidates. As mentioned above, the laser line extraction will output a sequence of image coordinates [uᵢ, vᵢ]^{T} (i=1, 2, . . . , n) to represent the laser light projected on the target apple. By using intrinsic camera parameters, the image coordinates [uᵢ, vᵢ]^{T} are first transformed to the normalized image coordinates, denoted by [u ᵢ, v ⱼ]^{T}∈P². Then, based on the trigonometry model of the laser-camera unit, the corresponding depth of each normalized image coordinate [u ᵢ, v ⱼ]^{T} can be computed by

$${z}_{i}^{c} = \frac{L}{sin ( α ) - {\overline{u}}_{i} cos ( α ) - {\overline{v}}_{i} tan ( β )} , i = 1 , 2 , … , n . \qquad ( 1 )$$

The mean value of z° is calculated as the depth range zc∈P of the target apple, that is,

$${z}^{c} = \frac{1}{n} {\sum }_{i = 1}^{n} {z}_{i}^{c} . \qquad ( 2 )$$

Finally, by combining the depth range with the center of the bounding box (i.e., the target apple center), back-projection is used to calculate the 3D position candidate. The laser-camera unit is expected to achieve better apple localization accuracy than the RGB-D camera, with an error of less than 7 mm. Therefore, the present perception component has been tailored for the current robotic system to calculate the 3D apple position based on the laser triangulation-based method in synergistic combination with the present mechanical structure of the 4-DOF manipulator.

The apples within the workspace are localized by the perception component and then assigned in turn as the target positions p_{d}=[x_{d}, y_{d}, z_{d}]^{T}∈P³, where the manipulator needs to reach. To facilitate the manipulation control, given a target position p_{d}, the quintic function is used to generate a corresponding reference trajectory pᵣ(t)=[xᵣ(t), yᵣ(t), zᵣ (t)]^{T}. This reference trajectory is a function of time with its terminus being the target position p_{d}. The introduction of the quintic function-based reference trajectory pᵣ brings the following advantages: First, the reference trajectory is continuously differentiable and its terminal velocity and acceleration are zero, which is conducive to ensuring that the end-effector approaches the desired position along a smooth path. Second, by adjusting function parameters, the velocity profile of the reference trajectory can be modified, and thus, the end-effector can reach the desired position within a specific time interval.

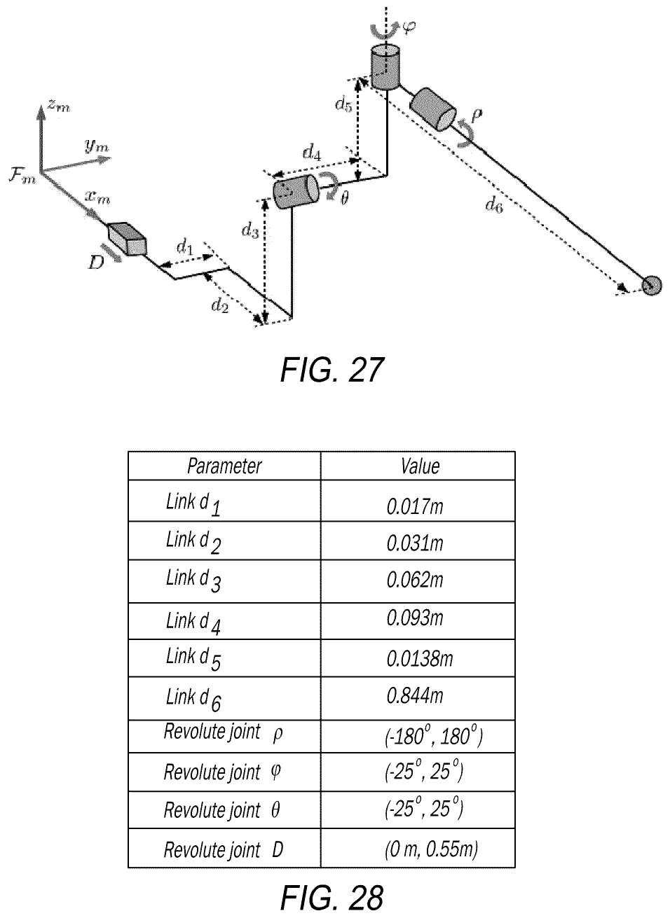

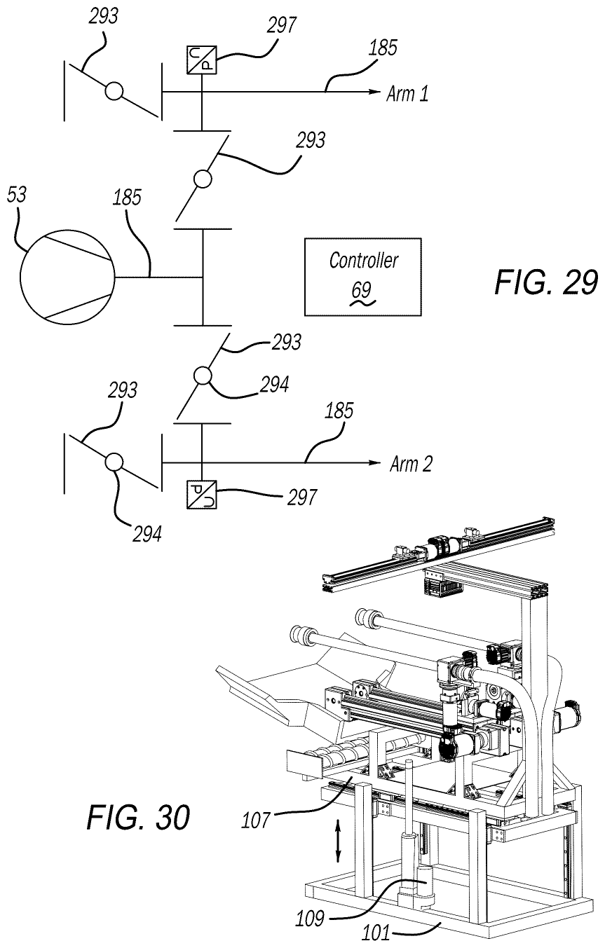

Given a target apple position and the generated reference trajectory using the planning algorithm, the control algorithms that drive the manipulator are next introduced to follow the reference trajectory. To achieve this, a motion control strategy exploits the mechanical structure of the 4-DOF manipulator, as is illustrated in FIGS. 27 and 28. Denote p=[x, y, z]^{T}∈P³ as the position of the end-effector. The forward kinematics function of the manipulator can be derived as follows:

$$x = {d}_{6} cos ( θ ) cos ( φ ) + {d}_{5} sin ( θ ) + {d}_{2} + D , \qquad ( 3 )$$

$$y = {d}_{6} sin ( φ ) + {d}_{4} + {d}_{1} ,$$

$$z = - {d}_{6} sin ( θ ) cos ( φ ) + {d}_{5} cos ( θ ) + {d}_{3} ,$$

where d₁, d₂, d₃, d₄, d₄, d₆∈P are the link lengths, and [φ, θ, D]^{T}∈P³ are the joint variables. Note that the revolute joint p is assembled to rotate the vacuum tube for fruit detachment and has no bearing on the end-effector position.

The planning algorithm will provide the reference trajectory pᵣ(t)=[xᵣ(t), yᵣ (t), zᵣ(t)]^{T} for the target position p_{d}. The objective of the manipulation control is to regulate the end-effector to follow the reference trajectory pᵣ and finally approach the target position p_{d}. The revolute joint parameters φ, θ, and prismatic joint parameter D are all driven by electrical motors, and a velocity-based control scheme is employed to generate explicit speed commands to smoothly adjust the joints based on real-time position feedback. Specifically, based on equation (3), the time derivative of [x, y, z]^{T} can be calculated as

$$\dot{x} = - {d}_{6} ( sin ( θ ) cos ( φ ) {ω}_{θ} + cos ( θ ) sin ( φ ) {ω}_{φ} ) + {d}_{5} cos ( θ ) {ω}_{θ} + {v}_{D} , \qquad ( 4 )$$

$$\dot{y} = {d}_{6} cos ( φ ) {ω}_{φ} ,$$

$$\dot{z} = - {d}_{6} ( cos ( θ ) cos ( φ ) {ω}_{θ} - sin ( θ ) sin ( φ ) {ω}_{φ} ) - {d}_{5} sin ( θ ) {ω}_{θ} ,$$

where ω_{φ}, ω_{θ}∈P are the angular velocity of the revolute joints φ and θ, respectively, and v_{D}∈P is the linear velocity of the prismatic joint D. Furthermore, the error signals [eₓ, e_{y}, e_{z}]^{T}∈P³ are constructed as

$${e}_{x} = x - {x}_{r} , \qquad ( 5 )$$

$${e}_{y} = y - {y}_{r} ,$$

$${e}_{z} = z - {z}_{r} .$$

Based on equations (4) and (5) and by virtue of Lyapunov-based control techniques and a robust control technique, the velocity controller is designed as

$${ω}_{φ} = \frac{- {k}_{y} {e}_{y} + {\dot{y}}_{r} + {η}_{y}}{{d}_{6} cos ( φ )} , \qquad ( 6 )$$

$${ω}_{θ} = \frac{{k}_{z} {e}_{z} + {d}_{6} sin ( θ ) sin ( φ ) {ω}_{φ} - {\dot{z}}_{r} + {η}_{z}}{{d}_{6} cos ( θ ) cos ( φ ) + {d}_{5} sin ( θ )} ,$$

$${v}_{D} = - {k}_{x} {e}_{x} + {d}_{6} ( sin ( θ ) cos ( φ ) {ω}_{θ} + cos ( θ ) sin ( φ ) {ω}_{φ} ) - {d}_{5} cos ( θ ) {ω}_{θ} + {\dot{x}}_{r} + {η}_{x} ,$$

where kₓ, k_{y}, k_{z}∈P⁺ are positive constant gains, and nₓ, n_{y}, n_{z}∈P are given by

$${η}_{x} = {l}_{x} {\int }_{0}^{t} ( {e}_{x} ( τ ) + sgn ( {e}_{x} ( τ ) ) ) ⅆ τ , \qquad ( 7 )$$

$${η}_{y} = {l}_{y} {\int }_{0}^{t} ( {e}_{y} ( τ ) + sgn ( {e}_{y} ( τ ) ) ) ⅆ τ ,$$

$${η}_{z} = {l}_{z} {\int }_{0}^{t} ( {e}_{z} ( τ ) + sgn ( {e}_{z} ( τ ) ) ) ⅆ τ .$$

In equation (7), lₓ, l_{y}, l_{z}∈P⁺ are positive constant gains and sgn (·) is the standard signum function. The control scheme designed in equation (6) has several advantages including a hybrid velocity/position control method to adjust the manipulator's motor actuation joints, wherein the controller is unified and can coordinate with the current manipulator to achieve faster and more accurate movement. Furthermore, the present control method beneficially eliminates the influence of bounded disturbances while ensuring asymptotic error convergence.

Moreover, a comprehensive planning software module will optionally determine an optimal apple picking sequence and generate collision-free trajectories. The motion controller will then work in tandem with the collision-free trajectories to direct the manipulator toward target apples, without colliding obstacles in its path, to the target fruit. Various techniques, such as the traveling salesman algorithm and the potential field algorithm, in the programmed instructions may be employed to plan the most efficient apple picking sequence and effectively harvest the apples with minimal movement and collision risks.

In an alternate configuration, alternate laser or other light sources may be used. A red laser source is used in the present apparatus to facilitate the fruit localization since the red laser line had higher contrasts with the background being red apples. But different colored laser lines may be desired for use on green and yellow apples. Alternately, one or more RGB laser line detection cameras and one or more ToF localization cameras may be moveable or non-centrally mounted, although some of the present advantages may not be achieved.

While various configurations have been disclosed hereinabove, additional variations may be employed with the present robotic harvesting apparatus and method. For example, additional or different electrical or mechanical components may be used with the present system, such as limit switches, potentiometers, force transducers, brackets and the like, although certain advantages may not be realized. Furthermore, additional or modified software steps may be provided if they have similar functionality to those that are disclosed herein, although some benefits may not be achieved. As another example, alternate actuators such as hydraulic or pneumatic fluid cylinders, solenoids, linear motors and the like may be used, although all of the present advantages may not be obtained. Alternately, a vacuum pump may be dedicated to and coupled to each arm in separate manners, thereby using multiple vacuum pumps, although many of the present advantages may not be realized. Alternately, more than two independently movable arms, such as three or four, may be employed in the harvesting apparatus and operating with a central universal camera and vacuum source, or multiple cameras and vacuum sources for groups of the arms. Structural and functional features of each embodiment may be interchanged between other embodiments disclosed herein, and all of the claims may be multiply dependent on the others in all combinations. It is intended by the following claims to cover these and any other departures from the disclosed embodiments which fall within the true spirit and scope of the present invention.

1. A fruit harvesting apparatus comprising:
(a) multiple fruit-picking arms;
(b) at least one arm actuator configured to advance and rotate each of the multiple arms;
(c) a vacuum source coupled to the arms configured to suck fruit to a distal end of each of the multiple arms, but the distal ends of the multiple arms deterring the fruit from traveling within the multiple arms;
(d) a light source emitting a light pattern on the fruit before picking, and at least one sensor comprises a central camera located above and between proximal ends of the multiple arms; and
(e) the at least one sensor and a controller configured to:
locate the fruit;
move the multiple arms to align the distal ends thereof with the located fruit;
cause the distal ends to pick the fruit; and
cause the vacuum pressure to be released so the distal ends drop the fruit.

2. (canceled)

3. The apparatus of claim 1, further comprising:
(a) a wheeled vehicle including a platform;
(b) a frame mounted upon the platform, the frame including substantially horizontally elongated beams with posts vertically extending therefrom;
(c) a lift including substantially horizontally elongated beams and laterally crossing buttresses;
(d) a first actuator operably raising and lowering the lift relative to the frame;
(e) a second actuator operably sliding the lift forward and backward relative to the frame; and
(f) the multiple arms being coupled to and moveable with the lift.

4. The apparatus of claim 1, further comprising:
(a) a chute located below the ends of the multiple arms when the arms are in a retracted position, the chute being wide enough to receive the fruit dropped from the multiple arms; and
(b) rotatable rolls located adjacent to a bottom and inboard edge of the chute, each of the rolls including a spiral thread and a soft covering material.

5. The apparatus of claim 1, wherein the controller, which is programmable and connected to the at least one actuator and the sensor, is configured to prevent a collision between the multiple arms when the multiple arms are picking the fruit.

6. The apparatus of claim 1, wherein the controller, which includes programmable software stored on non-transient memory and run on a microprocessor, is configured to:
(a) locate the fruit;
(b) align a first of the arms to a first of the fruit, by energizing the at least one of the arm actuators to pan, tilt and advance the first of the arms;
(c) align a second of the arms to a second of the fruit, by energizing the at least one of the arm actuators to pan, tilt and advance the second of the arms; and
(d) control vacuum pressure within the arms in an alternating manner between the arms.

7. The apparatus of claim 1, wherein the controller, which includes programmable software stored on non-transient memory and run on a microprocessor, is configured to:
(a) locate the fruit, even when occluded on a tree;
(b) prioritize picking order or sequence of the fruit between the arms;
(c) align a first of the arms to a first of the fruit, by energizing the at least one of the arm actuators to pan, tilt and advance the first of the arms;
(d) align a second of the arms to a second of the fruit, by energizing the at least one of the arm actuators to pan, tilt and advance the second of the arms.

8. The apparatus of claim 1, wherein the controller, which includes programmable software stored on non-transient memory and run on a microprocessor, is configured to:
(a) locate the fruit;
(b) determine an occlude-occludee relationship between the fruit and branches;
(c) generate a 3D position of the fruit via laser triangulation;
(d) assign the fruit to be picked by each of the multiple arms, the assignment comprising programmed instructions configured to:
(i) allocate each of the fruit to be picked to each of the multiple arms based as least in part on (a)-(c);
(ii) substantially balance a picking volume for each of the multiple arms;
(iii) sort picking priority based on at least a distance from the fruit to an arm position and distance; and
(e) aligning each of the multiple arms to the fruit based at least in part on the assignment instructions.

9. The apparatus of claim 1, wherein the vacuum source is a single vacuum pump coupled to all of the multiple arms.

10. The apparatus of claim 1, wherein the vacuum source includes a separate vacuum pump coupled to each of the multiple arms.

11. The apparatus of claim 1, wherein the sensor and the camera comprise a single laser line detection camera and a single localization camera stationarily mounted above and between proximal ends of the multiple arms, further comprising multiple lasers laterally movable to emit laser lines on the fruit.

12. The apparatus of claim 1, wherein each of the multiple arms are configured to automatically align with, pick and drop each fruit, which is an apple.

13. A fruit harvesting apparatus comprising:
(a) multiple fruit-picking arms;
(b) at least one arm actuator configured to move each of the multiple arms;
(c) a vacuum source coupled to the arms configured to suck fruit to a distal end of each of the multiple arms;
(d) at least one sensor and controller configured to:
locate the fruit;
prioritize alignment of each of the multiple arms with the located fruit;
move the multiple arms to align the distal ends thereof with the located fruit;
cause the distal ends to pick the fruit;
prevent collision between the multiple arms during the alignment and the picking; and
control vacuum pressure within the arms in an alternating manner between the arms.

14. The apparatus of claim 13, further comprising a light source emitting a light pattern on the fruit before picking, and the at least one sensor comprises a central camera located above and between proximal ends of the multiple arms.

15. The apparatus of claim 13, further comprising:
(a) a wheeled vehicle including a platform;
(b) a frame mounted upon the platform, the frame including substantially horizontally elongated beams with posts vertically extending therefrom;
(c) a lift;
(d) a first actuator operably raising and lowering the lift relative to the frame;
(e) a second actuator operably sliding the lift forward and backward relative to the frame; and
(f) the multiple arms being coupled to and moveable with the lift.

16. The apparatus of claim 13, further comprising:
(a) a chute located below the ends of the multiple arms when the arms are in a retracted position, the chute being wide enough to receive the fruit dropped from the multiple arms; and
(b) rotatable rolls located adjacent to a bottom and inboard edge of the chute, each of the rolls including a spiral thread and a soft covering material.

17. The apparatus of claim 13, wherein the controller, which includes programmable software stored on non-transient memory and run on a microprocessor, is configured to:
(a) locate the fruit;
(b) align a first of the arms to a first of the fruit, by energizing the at least one of the arm actuators to pan, tilt and advance the first of the arms;
(c) align a second of the arms to a second of the fruit, by energizing the at least one of the arm actuators to pan, tilt and advance the second of the arms;
(d) control energization of electric motors to vary positions of multiple airflow valves in order to control the vacuum pressure within the arms in the alternating manner between the arms, so the arms will grasp and then drop the fruit onto a shared chute below the arms; and
(e) receive feedback from a pressure sensor indicating successful fruit grasping.

18. The apparatus of claim 13, wherein the controller, which includes programmable software stored on non-transient memory and run on a microprocessor, and the sensor includes at least one camera, are configured to:
(a) locate the fruit, even when occluded on a tree;
(b) prioritize picking order or sequence of the fruit between the arms;
(c) align a first of the arms to a first of the fruit, by energizing the at least one of the arm actuators to pan, tilt and advance the first of the arms; and
(d) align a second of the arms to a second of the fruit, by energizing the at least one of the arm actuators to pan, tilt and advance the second of the arms.

19. The apparatus of claim 13, wherein the vacuum source is a single vacuum pump coupled to all of the multiple arms, and the sensor comprises a single laser line detection camera and a single localization camera stationarily mounted above and between proximal ends of the multiple arms, further comprising multiple lasers laterally movable to emit laser lines on the fruit.

20. A fruit harvesting apparatus comprising:
multiple fruit-picking arms;
arm actuators configured to advance and rotate each of the multiple arms;
a vacuum source coupled to the arms configured to suck fruit to a distal end of each of the multiple arms;
a controller, which includes programmable software stored on non-transient memory and run on a microprocessor, configured to automatically:
(a) locate the fruit;
(b) determine an occlude-occludee relationship between the fruit and branches;
(c) generate a 3D position of the fruit via laser triangulation;
(d) assign the fruit to be picked by each of the multiple arms, the assignment comprising programmed instructions configured to:
allocate each of the fruit to be picked to each of the multiple arms based as least in part on (a)-(c);
substantially balance a picking volume for each of the multiple arms;
sort picking priority based on at least a distance from the fruit to an arm position and distance; and
(e) energize the arm actuators to align each of the multiple arms to the fruit and pick the fruit at least in part on the assignment instructions, without collision between the multiple arms.

21. The apparatus of claim 20, wherein the programmed instructions are further configured to:
(a) move a first of the arms to a first of the fruit, by energizing the arm actuators to pan, tilt and advance the first of the arms;
(b) simultaneously move a second of the arms to a second of the fruit, by energizing the arm actuators to pan, tilt and advance the second of the arms; and
(c) control vacuum pressure within the arms in an alternating manner between the arms.

22. The apparatus of claim 20, further comprising a camera centrally located between and above proximal ends of the multiple arms, and moveable lasers emitting a light line on the fruit, and the programmed instructions further being configured to determine a 3D location of the fruit and occluding tree branches from the camera.

23. A method of harvesting fruit from a tree, the method comprising:
(a) automatically optically locating a first fruit and a second fruit in a tree, and using a shared optical assembly to locate the fruit, even when occluded within the tree;
(b) automatically determining a picking sequence of the first and the second fruit;
(c) automatically moving and aligning a first arm to the first fruit and a second arm to the second fruit;
(d) automatically applying a vacuum pressure to temporarily pull the first fruit against an end of the first arm and the second fruit against an end of the second arm, and using a shared vacuum pump for the first and the second arms;
(e) automatically rotating the first arm to pick the first fruit off of the tree and the second arm to pick the second fruit off of the tree;
(f) automatically retracting the first arm and attached first fruit and automatically retracting the second arm and the attached second fruit;
(g) automatically preventing a collision between the arms during the moving; and
(h) automatically releasing the vacuum pressure to drop the first fruit onto a receiving surface and to drop the second fruit onto the receiving surface.

24. (canceled)

25. The method of claim 23, further comprising:
(a) moving a frame on a wheeled vehicle between multiples of the tree;
(b) emitting light on the first fruit from a light source before picking;
(c) detecting the emitted light on the first fruit by a camera located above and between proximal ends of the first and second arms;
(d) energizing an elevator actuator to raise and lowering a lift relative to the frame, the first and second arms being movably coupled to and moveable with the lift; and
(e) energizing an advancing actuator to move the lift forward and backward relative to the frame.

26. The method of claim 23, further comprising using programmed instructions to:
(a) energize first arm actuators to pan, tilt and advance the first of the arms;
(b) energize second arm actuators to pan, tilt and advance the second arm; and
(c) control vacuum pressure within the first and the second arms in an alternating manner between the arms to operate the picking and the dropping actions.

27. The method of claim 23, further comprising automatically:
(a) determining an occlude-occludee relationship between the fruit and branches;
(b) determining a 3D position of the fruit via laser triangulation with a camera of the shared optical assembly;
(c) assigning the fruit to be picked by each of the arms, the assignment comprising:
allocating each of the fruit to be picked to each of the arms;
substantially balancing a picking volume for each of the arms;
sorting picking priority based on at least a distance from the fruit to an arm position and distance; and
(d) energizing arm actuators to align each of the arms to the fruit and picking the fruit at least in part on the assignment instructions.
